(19) United States
(12) Patent Application Publication
(10) Pub. No.: US 2024/0329369 A1
(43) Pub. Date: Oct. 3, 2024

(54) PROJECTION OPTICAL SYSTEM AND PROJECTOR

(71) Applicant: Seiko Epson Corporation, Tokyo (JP)

(72) Inventor: Akihisa KAGEYAMA, Matsumoto-shi (JP)

(73) Assignee: Seiko Epson Corporation, Tokyo (JP)

(21) Appl. No.: 18/619,926

(22) Filed: Mar. 28, 2024

(30) Foreign Application Priority Data
Mar. 29, 2023 (JP) 2023-052978

(51) Int. Cl. G02B 13/16; G02B 15/14

(52) U.S. Cl. CPC G02B 13/16; G02B 15/146

(57) ABSTRACT

A projection optical system includes: first lens group; second lens group; third lens group; fourth lens group; fifth lens group; sixth lens group; seventh lens group; eighth lens group; ninth lens group; and an aperture stop disposed between second and eighth lens groups, and these lens groups are in an order from magnification side to reduction side. The first lens group has negative power and includes one aspherical lens. Each of the second lens group, third lens group, fourth lens group, fifth lens group, sixth lens group, seventh lens group, eighth lens group, and ninth lens group includes only a spherical lens. During zooming, the first lens group and the ninth lens group are fixed, and the second lens group, the third lens group, the fourth lens group, the fifth lens group, the sixth lens group, the seventh lens group, and the eighth lens group move.

The present application is based on, and claims priority from JP Application Serial Number 2023-052978, filed Mar. 29, 2023, the disclosure of which is hereby incorporated by reference herein in its entirety.

### BACKGROUND

### 1. Technical Field

The present disclosure relates to a projection optical system and a projector.

### 2. Related Art

A projector that enlarges, by a projection optical system, a projection image displayed on an image display element and projects the enlarged projection image on a screen is disclosed in JP-A-2019-015830. The projection optical system in the document includes, in an order from a magnification side, a first lens unit having negative power, a second lens unit, a third lens unit, a fourth lens unit, a fifth lens unit, a sixth lens unit, a seventh lens unit, and an eighth lens unit having positive power. During zooming, the second lens unit to the seventh lens unit move. The first lens unit includes two aspherical lenses. A zoom ratio of the projection optical system is about 1.31 to 1.76. A total lens length of the projection optical system is 220 mm.

JP-A-2019-015830 is an example of the related art.

The projection optical system is required to have a compact total lens length while achieving a high zoom ratio. When making the total lens length compact, the total lens length of the projection optical system can be made compact by reducing the number of lenses for limiting various aberrations by using an aspherical lens. Here, the projection optical system including the aspherical lens can favorably correct various aberrations, but the various aberrations may not be corrected and may be deteriorated due to manufacturing accuracy of the aspherical lens and eccentricity of the aspherical lens with respect to an optical axis of the projection optical system. Therefore, since the projection optical system in JP-A-2019-015830 includes two aspherical lenses, various aberrations are likely to deteriorate due to influence of manufacturing accuracy of the aspherical lenses. Therefore, a projection optical system having a further compact total lens length and capable of further limiting various aberrations is required as the projection optical system.

### SUMMARY

In order to solve the above problems, a projection optical system according to the present disclosure includes: a first lens group; a second lens group; a third lens group; a fourth lens group; a fifth lens group; a sixth lens group; a seventh lens group; an eighth lens group; and a ninth lens group, these lens groups being in an order from a magnification side to a reduction side; and an aperture stop disposed between the second lens group and the eighth lens group. The first lens group has negative power and includes one aspherical lens. Each of the second lens group, the third lens group, the fourth lens group, the fifth lens group, the sixth lens group, the seventh lens group, the eighth lens group, and the ninth lens group includes only a spherical lens. During zooming, the first lens group and the ninth lens group are fixed, and the second lens group, the third lens group, the fourth lens group, the fifth lens group, the sixth lens group, the seventh lens group, and the eighth lens group move.

Next, a projector according to the present disclosure includes the above-described projection optical system, and an image forming element configured to form a projection image on a reduction side conjugate plane of the projection optical system.

### BRIEF DESCRIPTION OF THE DRAWINGS

FIG. 1 is a diagram showing a schematic configuration of a projector including a projection optical system according to the present disclosure.

FIG. 2 is a ray diagram of a projection optical system according to a first embodiment.

FIG. 3 is a diagram showing a coma aberration at a wide-angle end of the projection optical system according to the first embodiment.

FIG. 4 is a diagram showing a coma aberration at a telephoto end of the projection optical system according to the first embodiment.

FIG. 5 is a diagram showing a spherical aberration, an astigmatism, and a distortion at the wide-angle end of the projection optical system according to the first embodiment.

FIG. 6 is a diagram showing a spherical aberration, an astigmatism, and a distortion at the telephoto end of the projection optical system according to the first embodiment.

FIG. 7 is a ray diagram of a projection optical system according to a second embodiment.

FIG. 8 is a diagram showing a coma aberration at a wide-angle end of the projection optical system according to the second embodiment.

FIG. 9 is a diagram showing a coma aberration at a telephoto end of the projection optical system according to the second embodiment.

FIG. 10 is a diagram showing a spherical aberration, an astigmatism, and a distortion at the wide-angle end of the projection optical system according to the second embodiment.

FIG. 11 is a diagram showing a spherical aberration, an astigmatism, and a distortion at the telephoto end of the projection optical system according to the second embodiment.

FIG. 12 is a ray diagram of a projection optical system according to a third embodiment.

FIG. 13 is a diagram showing a coma aberration at a wide-angle end of the projection optical system according to the third embodiment.

FIG. 14 is a diagram showing a coma aberration at a telephoto end of the projection optical system according to the third embodiment.

FIG. 15 is a diagram showing a spherical aberration, an astigmatism, and a distortion at the wide-angle end of the projection optical system according to the third embodiment.

FIG. 16 is a diagram showing a spherical aberration, an astigmatism, and a distortion at the telephoto end of the projection optical system according to the third embodiment.

FIG. 17 is a ray diagram of a projection optical system according to a fourth embodiment.

FIG. 18 is a diagram showing a coma aberration at a wide-angle end of the projection optical system according to the fourth embodiment.

FIG. 19 is a diagram showing a coma aberration at a telephoto end of the projection optical system according to the fourth embodiment.

FIG. 20 is a diagram showing a spherical aberration, an astigmatism, and a distortion at the wide-angle end of the projection optical system according to the fourth embodiment.

FIG. 21 is a diagram showing a spherical aberration, an astigmatism, and a distortion at the telephoto end of the projection optical system according to fourth embodiment.

FIG. 22 is a ray diagram of a projection optical system according to a fifth embodiment.

FIG. 23 is a diagram showing a coma aberration at a wide-angle end of the projection optical system according to the fifth embodiment.

FIG. 24 is a diagram showing a coma aberration at a telephoto end of the projection optical system according to the fifth embodiment.

FIG. 25 is a diagram showing a spherical aberration, an astigmatism, and a distortion at the wide-angle end of the projection optical system according to the fifth embodiment.

FIG. 26 is a diagram showing a spherical aberration, an astigmatism, and a distortion at the telephoto end of the projection optical system according to the fifth embodiment.

FIG. 27 is a ray diagram of a projection optical system according to a sixth embodiment.

FIG. 28 is a diagram showing a coma aberration at a wide-angle end of the projection optical system according to the sixth embodiment.

FIG. 29 is a diagram showing a coma aberration at a telephoto end of the projection optical system according to the sixth embodiment.

FIG. 30 is a diagram showing a spherical aberration, an astigmatism, and a distortion at the wide-angle end of the projection optical system according to the sixth embodiment.

FIG. 31 is a diagram showing a spherical aberration, an astigmatism, and a distortion at the telephoto end of the projection optical system according to the sixth embodiment.

FIG. 32 is a ray diagram of a projection optical system according to a seventh embodiment.

FIG. 33 is a diagram showing a coma aberration at a wide-angle end of the projection optical system according to the seventh embodiment.

FIG. 34 is a diagram showing a coma aberration at a telephoto end of the projection optical system according to the seventh embodiment.

FIG. 35 is a diagram showing a spherical aberration, an astigmatism, and a distortion at the wide-angle end of the projection optical system according to the seventh embodiment.

FIG. 36 is a diagram showing a spherical aberration, an astigmatism, and a distortion at the telephoto end of the projection optical system according to the seventh embodiment.

FIG. 37 is a ray diagram of a projection optical system according to an eighth embodiment.

FIG. 38 is a diagram showing a coma aberration at a wide-angle end of the projection optical system according to the eighth embodiment.

FIG. 39 is a diagram showing a coma aberration at a telephoto end of the projection optical system according to the eighth embodiment.

FIG. 40 is a diagram showing a spherical aberration, an astigmatism, and a distortion at the wide-angle end of the projection optical system according to the eighth embodiment.

FIG. 41 is a diagram showing a spherical aberration, an astigmatism, and a distortion at the telephoto end of the projection optical system according to the eighth embodiment.

### DESCRIPTION OF EMBODIMENTS

A projection optical system and a projector according to embodiments of the present disclosure will be described below with reference to the drawings.

### Projector

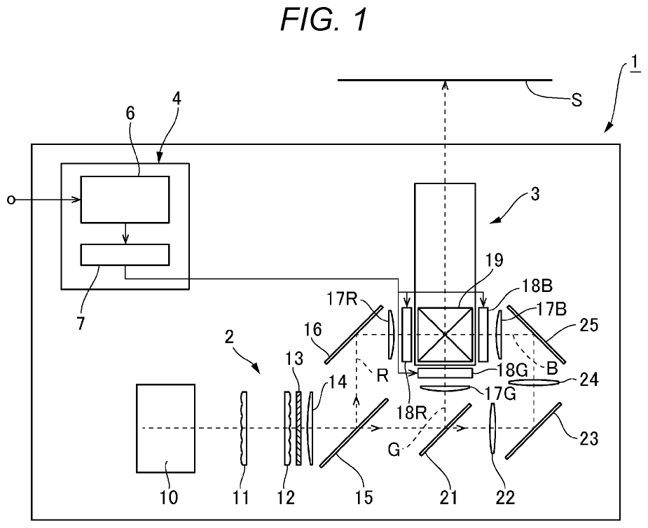

FIG. 1 is a diagram showing a schematic configuration of a projector including a projection optical system 3 according to the present disclosure. As shown in FIG. 1, the projector 1 includes an image forming unit 2 that generates a projection image to be projected onto a screen S, the projection optical system 3 that enlarges the projection image and projects the enlarged image onto the screen S, and a control unit 4 that controls an operation of the image forming unit 2.

### Image Forming Unit and Control Unit

The image forming unit 2 includes a light source 10, a first integrator lens 11, a second integrator lens 12, a polarization conversion element 13, and a superimposing lens 14. The light source 10 includes, for example, an ultra-high pressure mercury lamp or a solid light source. Each of the first integrator lens 11 and the second integrator lens 12 includes a plurality of lens elements arranged in an array. The first integrator lens 11 divides a light beam from the light source 10 into a plurality of parts. The lens elements of the first integrator lens 11 condense the light beam from the light source 10 to a vicinity of the lens elements of the second integrator lens 12.

The polarization conversion element 13 converts light from the second integrator lens 12 into predetermined linearly polarized light. The superimposing lens 14 superimposes images of the lens elements of the first integrator lens 11 on display areas of a liquid crystal panel 18R, a liquid crystal panel 18G, and a liquid crystal panel 18B to be described later, via the second integrator lens 12.

The image forming unit 2 also includes a first dichroic mirror 15, a reflection mirror 16, a field lens 17R, and the liquid crystal panel 18R. The first dichroic mirror 15 reflects R light that is a part of rays incident from the superimposing lens 14 and transmits G light and B light that are a part of the rays incident from the superimposing lens 14. The R light reflected by the first dichroic mirror 15 enters the liquid crystal panel 18R through the reflection mirror 16 and the field lens 17R. The liquid crystal panel 18R is an image forming element. The liquid crystal panel 18R forms a red projection image by modulating the R light according to an image signal.

The image forming unit 2 further includes a second dichroic mirror 21, a field lens 17G, and a liquid crystal panel 18G. The second dichroic mirror 21 reflects the G light that is a part of rays from the first dichroic mirror 15 and transmits the B light that is a part of rays from the first dichroic mirror 15. The G light reflected by the second dichroic mirror 21 enters the liquid crystal panel 18G through the field lens 17G. The liquid crystal panel 18G is an image forming element. The liquid crystal panel 18G forms a green projection image by modulating the G light according to an image signal.

The image forming unit 2 also includes a relay lens 22, a reflection mirror 23, a relay lens 24, a reflection mirror 25, a field lens 17B, a liquid crystal panel 18B, and a cross dichroic prism 19. The B light transmitted through the second dichroic mirror 21 enters the liquid crystal panel 18B through the relay lens 22, the reflection mirror 23, the relay lens 24, the reflection mirror 25, and the field lens 17B. The liquid crystal panel 18B is an image forming element. The liquid crystal panel 18B forms a blue projection image by modulating the B light according to an image signal.

The liquid crystal panel 18R, the liquid crystal panel 18G, and the liquid crystal panel 18B surround the cross dichroic prism 19 from three directions. The cross dichroic prism 19 is a prism for light synthesis and generates a projection image by synthesizing the light modulated by the liquid crystal panels 18R, 18G, and 18B.

The projection optical system 3 enlarges the projection image synthesized by the cross dichroic prism 19 and projects the enlarged projection image onto the screen S.

The control unit 4 includes an image processing unit 6 to which an external image signal such as a video signal is input, and a display driving unit 7 that drives the liquid crystal panel 18R, the liquid crystal panel 18G, and the liquid crystal panel 18B based on an image signal output from the image processing unit 6.

The image processing unit 6 converts an image signal received from an external device into an image signal including gradation of each color. The display driving unit 7 operates the liquid crystal panel 18R, the liquid crystal panel 18G, and the liquid crystal panel 18B based on projection image signals of colors output from the image processing unit 6. Accordingly, the image processing unit 6 displays projection images corresponding to the image signals on the liquid crystal panel 18R, the liquid crystal panel 18G, and the liquid crystal panel 18B.

### Projection Optical System

Next, the projection optical system 3 will be described. As shown in FIG. 1, the screen S is disposed on a magnification side conjugate plane of the projection optical system 3. The liquid crystal panel 18R, the liquid crystal panel 18G, and the liquid crystal panel 18B are disposed on a reduction side conjugate plane of the projection optical system 3.

Hereinafter, first to eighth embodiments will be described as configuration examples of the projection optical system 3 mounted on the projector 1.

### First Embodiment

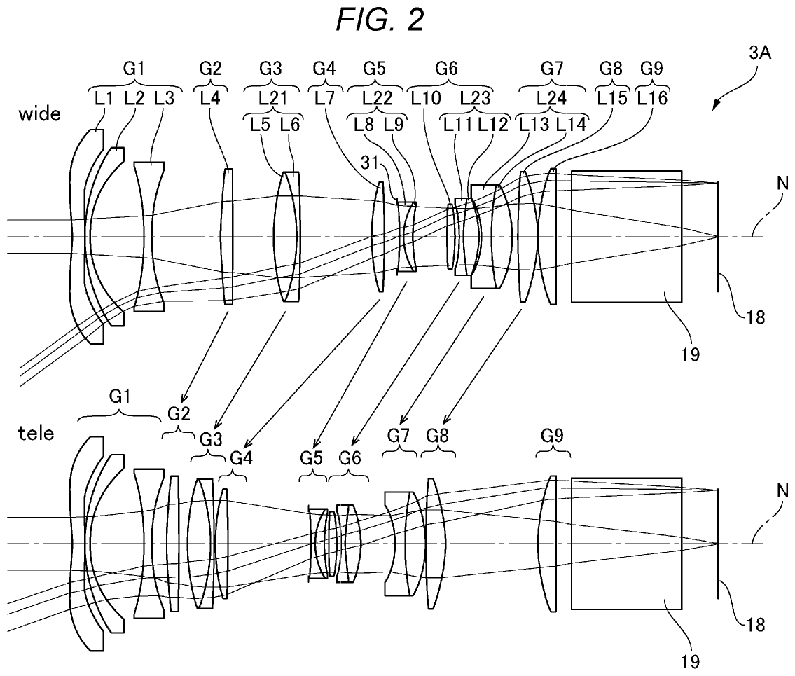

As shown in FIG. 2, a projection optical system 3A includes, in an order from a magnification side to a reduction side, a first lens group G1 having negative power, a second lens group G2 having positive power, a third lens group G3 having positive power, a fourth lens group G4 having positive power, a fifth lens group G5 having negative power, a sixth lens group G6 having positive power, a seventh lens group G7 having negative power, an eighth lens group G8 having positive power, and a ninth lens group G9 having positive power. The projection optical system 3A includes an aperture stop 31 disposed between the fourth lens group G4 and the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes one lens L4. The lens L4 has positive power. The lens L4 has convex shapes on magnification side and reduction side surfaces thereof. The third lens group G3 includes two lenses L5 to L6. The lenses L5 to L6 are disposed in this order from the magnification side to the reduction side. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The fourth lens group G4 includes one lens L7. The lens L7 has positive power. The lens L7 has convex shapes on magnification side and reduction side surfaces thereof.

The fifth lens group G5 includes two lenses L8 to L9. The lenses L8 to L9 are disposed in this order from the magnification side to the reduction side. The lens L8 has negative power. The lens L8 has concave shapes on magnification side and reduction side surfaces thereof. The lens L9 has negative power. The lens L9 is a meniscus lens. The lens L9 has a convex shape on a magnification side surface thereof and a concave shape on a reduction side surface thereof. The lens L8 and the lens L9 are cemented to form a cemented lens L22.

The sixth lens group G6 includes three lenses L10 to L12. The lenses L10 to L12 are disposed in this order from the magnification side toward the reduction side. The lens L10 has positive power. The lens L10 has convex shapes on magnification side and reduction side surfaces thereof. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form a cemented lens L23.

The seventh lens group G7 includes two lenses L13 to L14. The lenses L13 to L14 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form a cemented lens L24.

The eighth lens group G8 includes one lens L15. The lens L15 has positive power. The lens L15 has convex shapes on magnification side and reduction side surfaces thereof. The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3A, a reduction side from the lens L16 of the ninth lens group G9 is telecentric. The term telecentric means that a central ray of each light beam passing between the lens L16 and the liquid crystal panel 18 that is disposed on the reduction side conjugate plane is parallel to an optical axis or substantially parallel to the optical axis. In this specification, the term telecentric means that an angle formed between the central ray of each light beam and an optical axis N of the projection optical system 3A is within ±5°.

The projection optical system 3A is a zoom lens and changes an angle of view between a wide-angle end and a telephoto end. In the projection optical system 3A, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3A is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the seven lenses L1 to L7), which are disposed on the magnification side with respect to the aperture stop 31, at the wide-angle end is F1, a focal length of the fifth lens group G5 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3A is as follows.

| FNo (wide-angle end to telephoto end) | 2.17-2.94 | |
|---|---|---|
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 26.850 | mm |
| Fgs | −54.73 | mm |
| Fg1 | −29.820 | mm |
| Fg2 | 157.330 | mm |
| Fg3 | 74.859 | mm |

Lens data on the projection optical system 3A is as follows. Surface numbers are assigned in an order from the magnification side to the reduction side. Reference numerals are those of the screen, the lens, the dichroic prism, and the liquid crystal panel. A surface whose surface number is attached with * is an aspherical surface. R is a radius of curvature. Dis an axial surface interval. Nd is a refractive index of a d-line. Vd is an Abbe number of the d-line. A unit of R and D is mm.

| Reference | Surface | | | | |
|---|---|---|---|---|---|
| numeral | number | R | D | Nd | Vd |
| S | 0 | 1.00E+18 | 2400.0000 | | |
| L01 | 1* | −42.7605 | 4.0000 | 1.53504 | 55.711 |
| | 2* | −80.9075 | 0.1000 | | |
| L02 | 3 | 50.8071 | 1.5483 | 1.48749 | 70.236 |
| | 4 | 31.6845 | 17.3267 | | |
| L03 | 5 | −80.9908 | 2.5000 | 1.58313 | 59.375 |
| | 6 | 56.8331 | Variable | | |
| | | | interval 1 | | |
| L04 | 7 | 153.7668 | 4.0000 | 1.84666 | 23.778 |
| | 8 | −1053.3000 | Variable | | |
| | | | interval 2 | | |
| L05 | 9 | 68.7129 | 7.5590 | 1.80100 | 34.967 |
| L06 | 10 | −54.4837 | 1.2000 | 1.84666 | 23.778 |
| | 11 | −325.9170 | Variable | | |
| | | | interval 3 | | |
| L07 | 12 | 59.2704 | 4.2315 | 1.62299 | 58.166 |
| | 13 | −248.2260 | Variable | | |
| | | | interval 4 | | |
| 31 | 14 | 1.00E+18 | 0.7644 | | |
| L08 | 15 | −87.4190 | 1.2000 | 1.57135 | 52.952 |
| L09 | 16 | 19.3906 | 2.9857 | 1.62041 | 60.290 |
| | 17 | 44.2473 | Variable | | |
| | | | interval 5 | | |
| L10 | 18 | 166.2055 | 2.6228 | 1.58313 | 59.386 |
| | 19 | −55.0546 | 1.5000 | | |
| L11 | 20 | −33.6834 | 1.2000 | 1.72825 | 28.461 |
| L12 | 21 | 57.3284 | 5.0986 | 1.49700 | 81.546 |
| | 22 | −30.1304 | Variable | | |
| | | | interval 6 | | |
| L13 | 23 | −24.7792 | 3.0826 | 1.71736 | 29.518 |
| L14 | 24 | 79.6539 | 6.7274 | 1.49700 | 81.546 |
| | 25 | −34.6391 | Variable | | |
| | | | interval 7 | | |
| L15 | 26 | 250.6420 | 6.3553 | 1.80810 | 22.761 |
| | 27 | −51.4313 | Variable | | |
| | | | interval 8 | | |
| L16 | 28 | 55.4610 | 5.8045 | 1.49700 | 81.546 |
| | 29 | −2714.7800 | 5.1000 | | |
| 19 | 30 | 1.00E+18 | 35.5400 | 1.51680 | 64.198 |
| | 31 | 1.00E+18 | | | |
| 18 | 32 | 1.00E+18 | | | |

The variable interval 1, the variable interval 2, the variable interval 3, the variable interval 4, the variable interval 5, the variable interval 6, the variable interval 7, and the variable interval 8 during zooming are shown below. The variable interval 1 is an interval between the first lens group G1 and the second lens group G2, the variable interval 2 is an interval between the second lens group G2 and the third lens group G3, the variable interval 3 is an interval between the third lens group G3 and the fourth lens group G4, the variable interval 4 is an interval between the fourth lens group G4 and the fifth lens group G5, the variable interval 5 is an interval between the fifth lens group G5 and the sixth lens group G6, the variable interval 6 is an interval between the sixth lens group G6 and the seventh lens group G7, the variable interval 7 is an interval between the seventh lens group G7 and the eighth lens group G8, and the variable interval 8 is an interval between the eighth lens group G8 and the ninth lens group G9.

| | Wide-angle end | Telephoto end A |
|---|---|---|
| Variable interval 1 | 22.2870 | 5.4140 |
| Variable interval 2 | 13.0530 | 2.5500 |
| Variable interval 3 | 22.9110 | 0.4000 |
| Variable interval 4 | 4.9640 | 26.3010 |
| Variable interval 5 | 11.0000 | 1.5000 |
| Variable interval 6 | 0.8000 | 10.6930 |
| Variable interval 7 | 1.8420 | 0.1000 |
| Variable interval 8 | 0.1000 | 30.0000 |

Each aspherical coefficient is as follows.

| Surface number | 1 | 2 |
|---|---|---|
| R | −42.7605 | −80.9075 |
| Conic constant (K) | −16.3672 | −73.9469 |
| 4th-order | 2.17529900E−05 | 2.62645300E−05 |
| coefficient | | |
| 6th-order | −3.07738700E−08 | −2.83486700E−08 |
| coefficient | | |
| 8th-order | 3.34631000E−11 | 1.09303800E−11 |
| coefficient | | |
| 10th-order | −2.19160100E−14 | 2.85649500E−14 |
| coefficient | | |
| 12th-order | 7.74227200E−18 | −4.35734400E−17 |
| coefficient | | |
| 14th-order | −7.60324600E−22 | 2.18824500E−20 |
| coefficient | | |

Here, the projection optical system 3A according to the embodiment satisfies the following conditional expression, in which F1 is the composite focal length (the seven lenses L1 to L7) of all the lenses, which are disposed on the magnification side with respect to the aperture stop 31, at the wide-angle end, and Fw is the focal length of the entire system at the wide-angle end.

$$0.8 < F 1 / Fw < 1.6 \qquad ( 1 )$$

In the embodiment, variables are as below.

| | | |
|---|---|---|
| F1 | 26.850 | mm |
| Fw | 23.520 | mm |

Therefore, F1/Fw=1.142, which satisfies the conditional expression (1).

The projection optical system 3A according to the embodiment satisfies the following conditional expression, in which Fgs is the focal length of the fifth lens group G5 having negative power and disposed at the position closest to the aperture stop 31, and Fw is the focal length of the entire system at the wide-angle end.

$$- 9.2 < Fgs / Fw < 0 \qquad ( 2 )$$

In the embodiment, variables are as below.

| | | |
|---|---|---|
| Fgs | −54.73 | mm |
| Fw | 23.520 | mm |

Therefore, Fgs/Fw=−2.33, which satisfies the conditional expression (2).

The projection optical system 3A according to the embodiment satisfies the following conditional expression, in which Fw is the focal length of the entire system at the wide-angle end, Ft is the focal length of the entire system at the telephoto end, LL is the total lens length, and IH is the maximum image height of the liquid crystal panel 18.

3.4<(LL/IH)/(Ft/Fw)<4.9 (3)

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

The projection optical system 3A according to the embodiment satisfies the following conditional expression, in which Fw is the focal length of the entire system at the wide-angle end, and Fg1 is the focal length of the first lens group G1.

$$- 1.5 < Fg 1 / Fw < - 1.0 \qquad ( 4 )$$

In the embodiment, variables are as below.

| | | |
|---|---|---|
| Fw | 23.520 | mm |
| Fg1 | −29.820 | mm |

Therefore, μg1/Fw=−1.27, which satisfies the conditional expression (4).

The projection optical system 3A according to the embodiment satisfies the following conditional expression, in which Fw is the focal length of the entire system at the wide-angle end, and Fg2 is the focal length of the second lens group G2.

$$2. < Fg 2 / Fw < 7.5 \qquad ( 5 )$$

In the embodiment, variables are as below.

| | | |
|---|---|---|
| Fw | 23.520 | mm |
| Fg2 | 157.330 | mm |

Therefore, Fg2/Fw=6.689, which satisfies the conditional expression (5).

The third lens group G3 includes the lens L5 (positive lens) having positive power and the lens L6 (negative lens) having negative power. The projection optical system 3A according to the embodiment satisfies the following conditional expression, in which Fg2 is the focal length of the second lens group G2, and Fg3 is the focal length of the third lens group G3.

$$0.6 < Fg 2 / Fg 3 < 2.4 \qquad ( 6 )$$

In the embodiment, variables are as below.

| | | |
|---|---|---|
| Fg2 | 157.330 | mm |
| Fg3 | 74.859 | mm |

Therefore, Fg2/Fg3=2.102, which satisfies the conditional expression (6).

The projection optical system 3A according to the embodiment includes the cemented lens L21 which includes the lens L5 (first lens) having positive power and the lens L6 (second lens) having negative power and which is disposed on the magnification side with respect to the aperture stop 31. The projection optical system 3A according to the embodiment satisfies the following conditional expression, in which Nd1 is a refractive index of the lens L5, Nd2 is a refractive index of the lens L6, Vd1 is an Abbe number of a d-line of the lens L5, and Vd2 is an Abbe number of a d-line of the lens L6.

$$10 < \vert ( Nd 1 \times Vd 1 ) - ( Nd 2 \times Vd 2 ) \vert < 20 \qquad ( 7 )$$

In the embodiment, variables are as below.

| | |
|---|---|
| Nd1 | 1.801 |
| Nd2 | 1.847 |
| Vd1 | 34.967 |
| Vd2 | 23.778 |

Therefore, |(Nd1×Vd1)−(Nd2×Vd2)|=19.067, which satisfies the conditional expression (7).

The projection optical system 3A according to the embodiment satisfies the following conditional expression, in which Nd2 is the refractive index of the lens L6 (second lens).

$$Nd 2 < 1.85 \qquad ( 8 )$$

In the embodiment, Nd2=1.847, which satisfies the conditional expression (8).

### Effects

The projection optical system 3A according to the embodiment includes, in the order from the magnification side to the reduction side, the first lens group G1, the second lens group G2, the third lens group G3, the fourth lens group G4, the fifth lens group G5, the sixth lens group G6, the seventh lens group G7, the eighth lens group G8, and the ninth lens group G9. The projection optical system 3A includes an aperture stop 31 disposed between the fourth lens group G4 and the fifth lens group G5. The first lens group G1 has negative power and includes one aspherical lens. Each of the second lens group G2, the third lens group G3, the fourth lens group G4, the fifth lens group G5, the sixth lens group G6, the seventh lens group G7, the eighth lens group G8, and the ninth lens group G9 includes only a spherical lens. During zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move.

According to the embodiment, since the projection optical system 3A includes only one aspherical lens, deterioration in various aberrations due to manufacturing accuracy of the aspherical lens or eccentricity of the aspherical lens with respect to the optical axis of the projection optical system can be prevented as compared with a case where two or more aspherical lenses are provided. Since seven lens groups move during zooming, the projection optical system 3A has a compact total lens length while favorably correcting various aberrations even when including only one aspherical lens.

Here, as a comparative example, a third embodiment in JP-A-2019-015830, which is a related-art document, will be compared with the projection optical system 3A according to the embodiment. A projection optical system according to the comparative example includes, in an order from a magnification side, a first lens unit having negative power, a second lens unit, a third lens unit, a fourth lens unit, a fifth lens unit, a sixth lens unit, a seventh lens unit, and an eighth lens unit having positive power. During zooming, six lens units including the second lens unit to the seventh lens unit move. Data of the comparative example is as follows.

| | |
|---|---|
| Z | 1.760 |
| LL | 220.000 mm |

Comparing the projection optical system 3A according to the embodiment with the projection optical system according to the comparative example, the projection optical system 3A according to the embodiment has a higher zoom ratio than the projection optical system according to the comparative example. The projection optical system 3A according to the embodiment has a shorter total lens length than the projection optical system according to the comparative example. Accordingly, the projection optical system 3A according to the embodiment can achieve a higher zoom ratio and make the total lens length more compact than the projection optical system according to the comparative example.

In the projection optical system 3A according to the embodiment, during zooming from the wide-angle end to the telephoto end, the second lens group G2, the third lens group G3, the fourth lens group G4, the fifth lens group G5, the sixth lens group G6, the seventh lens group G7, and the eighth lens group G8 each move from the reduction side to the magnification side. Therefore, only the second lens group G2 to the eighth lens group G8 move in the same direction during zooming, and thus a structure of a lens barrel for holding the projection optical system 3A can be simplified.

In the projection optical system 3A according to the embodiment, the second lens group G2, the third lens group G3, and the eighth lens group G8 each have positive power. Therefore, various aberrations occurring in the first lens group G1 having negative power can be favorably corrected by the second lens group G2 and the third lens group G3 both having positive power. Since the eighth lens group G8 has positive power, it is easy to make the reduction side of the projection optical system 3A telecentric.

The projection optical system 3A according to the embodiment includes the aperture stop 31 disposed between the fourth lens group G4 and the fifth lens group G5. Therefore, the aperture stop 31 can favorably correct various aberrations while appropriately ensuring a peripheral light amount of rays passing through the projection optical system 3A.

The projection optical system 3A according to the embodiment satisfies the following conditional expression, in which F1 is the composite focal length (the seven lenses L1 to L7) of all the lenses, which are disposed on the magnification side with respect to the aperture stop 31, at the wide-angle end, and Fw is the focal length of the entire system at the wide-angle end.

$$0.8 < F 1 / Fw < 1.6 \qquad ( 1 )$$

Here, in the projection optical system at the wide-angle end, an angle of rays incident on the lens disposed on the magnification side with respect to the aperture stop 31 is large, and thus various aberrations are likely to occur, as compared with the projection optical system at the telephoto end. Therefore, the projection optical system 3A according to the embodiment satisfies the conditional expression (1), and thus can favorably correct various aberrations while making a lens length of all the lenses disposed on the magnification side with respect to the aperture stop 31 compact. When a value of the conditional expression (1) is below a lower limit, the lens length can be made compact, but since the lens length is compact, not all the number of lenses required for correcting various aberrations can be disposed in the projection optical system, making it difficult to favorably correct the various aberrations. When the value of the conditional expression (1) exceeds an upper limit, all the number of lenses required for correcting the various aberrations can be disposed in the projection optical system, but the lens length is increased.

The projection optical system 3A according to the embodiment satisfies the following conditional expression, in which Fgs is the focal length of the fifth lens group G5 having negative power and disposed at the position closest to the aperture stop 31, and Fw is the focal length of the entire system at the wide-angle end.

$$- 9.2 < Fgs / Fw < 0 \qquad ( 2 )$$

Here, in the projection optical system at the wide-angle end, an angle of rays incident on the fifth lens group G5 is large, and a field curve and an astigmatism are likely to occur, as compared with the projection optical system at the telephoto end. Therefore, the projection optical system 3A according to the embodiment satisfies the conditional expression (2), and thus can prevent occurrence of the field curve and the astigmatism. When a value of the conditional expression (2) is out of a range, the field curve and the astigmatism are likely to occur, and a resolution of a projection image projected by the projection optical system 3A deteriorates.

The projection optical system 3A according to the embodiment satisfies the following conditional expression, in which Fw is the focal length of the entire system at the wide-angle end, Ft is the focal length of the entire system at the telephoto end, LL is the total lens length, and IH is the maximum image height of the liquid crystal panel 18.

$$3.4 < ( LL / IH ) / ( Ft / Fw ) < 4.9 \qquad ( 3 )$$

The projection optical system 3A according to the embodiment satisfies the conditional expression (3), and thus can make the entire system compact while achieving a high zoom ratio. When a value of the conditional expression (3) is below a lower limit, the entire system can be made compact while achieving a high zoom ratio, but since the entire system is compact, not all the number of lenses required for correcting various aberrations can be disposed in the projection optical system, making it difficult to favorably correct the various aberrations. When the value of the conditional expression (3) exceeds an upper limit, all the number of lenses required for correcting the various aberrations can be disposed in the projection optical system, but it is difficult to achieve a high zoom ratio and to make the entire system compact.

The projection optical system 3A according to the embodiment satisfies the following conditional expression, in which Fw is the focal length of the entire system at the wide-angle end, and Fg1 is the focal length of the first lens group G1.

$$- 1.5 < Fg 1 / Fw < - 1.0 \qquad ( 4 )$$

Here, in the projection optical system at the wide-angle end, an angle of rays incident on the first lens group G1 is large, and thus various aberrations are likely to occur, as compared with the projection optical system at the telephoto end. Therefore, the projection optical system 3A according to the embodiment satisfies the conditional expression (4), and thus can ensure a back focus while favorably correcting various aberrations. When a value of the conditional expression (4) is below a lower limit, the back focus can be ensured, but since power of the first lens group G1 is too strong, it is difficult to correct the various aberrations. When the value of the conditional expression (4) exceeds an upper limit, power of the first lens group G1 is weak, and thus the various aberrations can be favorably corrected, but it is difficult to ensure the back focus.

The projection optical system 3A according to the embodiment satisfies the following conditional expression, in which Fw is the focal length of the entire system at the wide-angle end, and Fg2 is the focal length of the second lens group G2.

$$2. < Fg 2 / Fw < 7.5 \qquad ( 5 )$$

Here, in the projection optical system at the wide-angle end, an angle of rays incident on the second lens group G2 is large, and thus various aberrations are likely to occur, as compared with the projection optical system at the telephoto end. Therefore, the projection optical system 3A according to embodiment satisfies the conditional expression (5), and thus can favorably correct various aberrations while reducing a size thereof. When a value of the conditional expression (5) is below a lower limit, a size can be reduced, but since power of the second lens group G2 is too strong, it is difficult to correct the various aberrations. When the value of the conditional expression (5) exceeds an upper limit, power of the second lens group G2 is weak, and thus the various aberrations can be favorably corrected, but the projection optical system is increased in size.

In the projection optical system 3A according to the embodiment, at least the third lens group G3 in the second lens group G2 and the third lens group G3 includes the lens L5 (positive lens) having positive power and the lens L6 (negative lens) having negative power, and
the following conditional expression is satisfied, in which Fg2 is the focal length of the second lens group G2 and Fg3 is the focal length of the third lens group G3.

$$0.6 < Fg 2 / Fg 3 < 2.4 \qquad ( 6 )$$

According to the embodiment, by adjusting lens power of the positive lens and the negative lens, the projection optical system 3A according to the embodiment can be made to fall within a range of the conditional expression (6). Accordingly, the projection optical system 3A satisfies the conditional expression (6), and thus can favorably correct a chromatic aberration and various aberrations. When a value of the conditional expression (6) is below a lower limit, a difference in power between the second lens group G2 and the third lens group G3 is large, and thus the chromatic aberration can be favorably corrected, but it is difficult to correct the various aberrations. When the value of the conditional expression (6) exceeds an upper limit, the difference in power between the second lens group G2 and the third lens group G3 is small, and thus the various aberrations can be favorably corrected, but it is difficult to correct the chromatic aberration.

The projection optical system 3A according to the embodiment includes the cemented lens L21 which includes the lens L5 (first lens) having positive power and the lens L6 (second lens) having negative power and which is disposed on the magnification side with respect to the aperture stop 31, and
the following conditional expression is satisfied, in which Nd1 is the refractive index of the lens L5, Nd2 is the refractive index of the lens L6, Vd1 is the Abbe number of the d-line of the lens L5, and Vd2 is the Abbe number of the d-line of the lens L6.

$$10 < \vert ( Nd 1 \times Vd 1 ) - ( Nd 2 \times Vd 2 ) \vert < 20 \qquad ( 7 )$$

The projection optical system 3A according to the embodiment satisfies the conditional expression (7), and thus can favorably correct a chromatic aberration. When a value of the conditional expression (7) is out of a range, it is difficult to correct the chromatic aberration.

The projection optical system 3A according to the embodiment satisfies the following conditional expression, in which Nd2 is the refractive index of the lens L6 (second lens).

$$Nd 2 < 1.85 \qquad ( 8 )$$

The projection optical system 3A according to the embodiment satisfies the conditional expression (8), and thus can favorably correct a chromatic aberration and reduce a cost of a lens material. That is, when a value of the conditional expression (8) exceeds an upper limit, it is difficult to favorably correct the chromatic aberration, and the cost of the lens material increases.

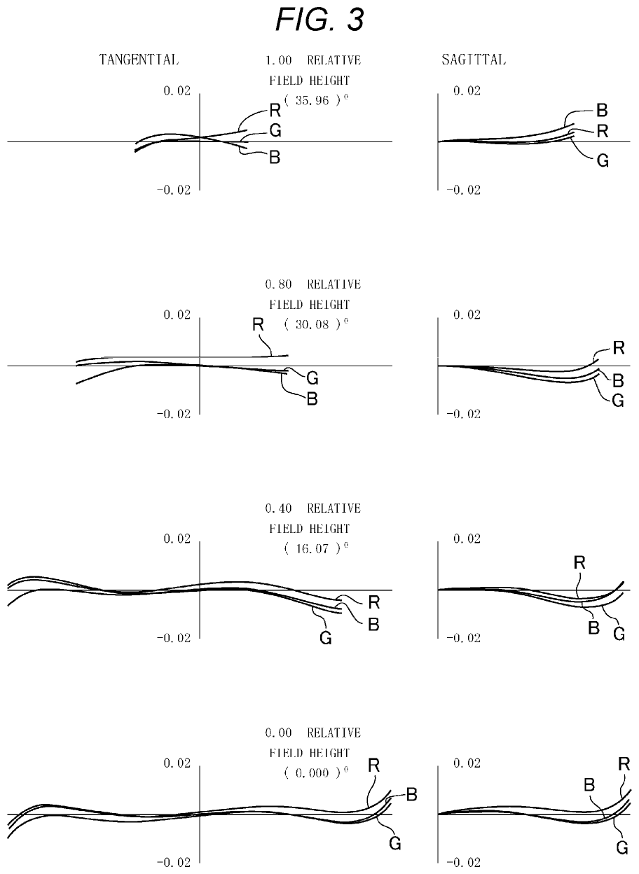

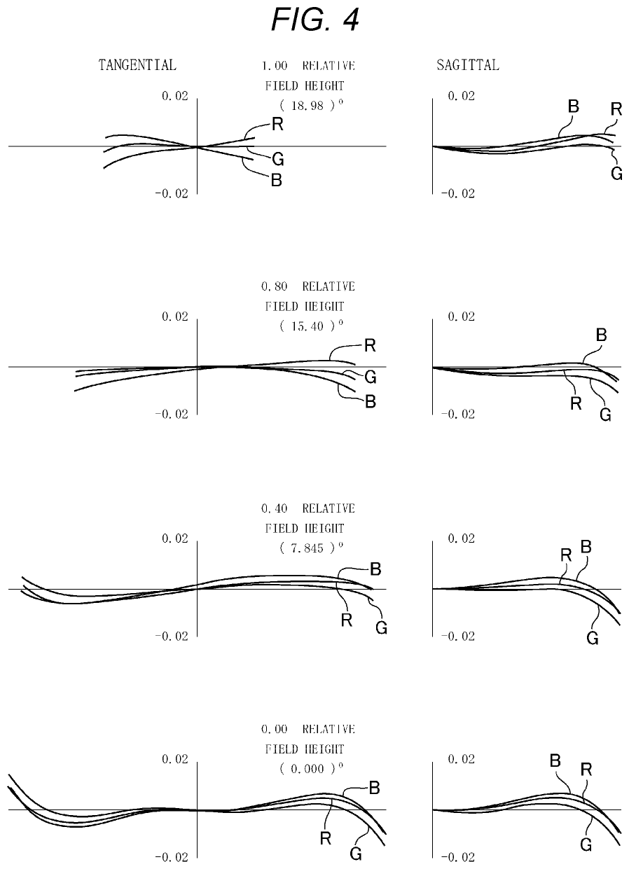

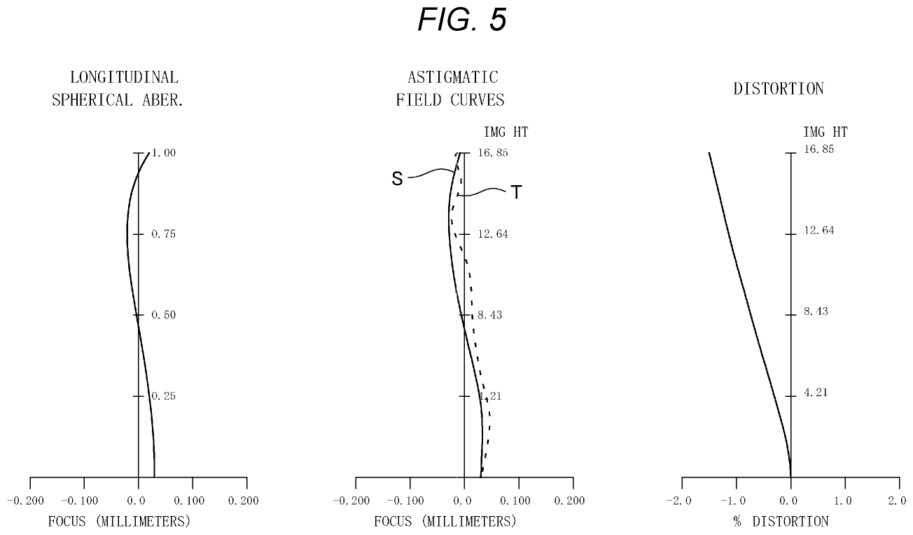

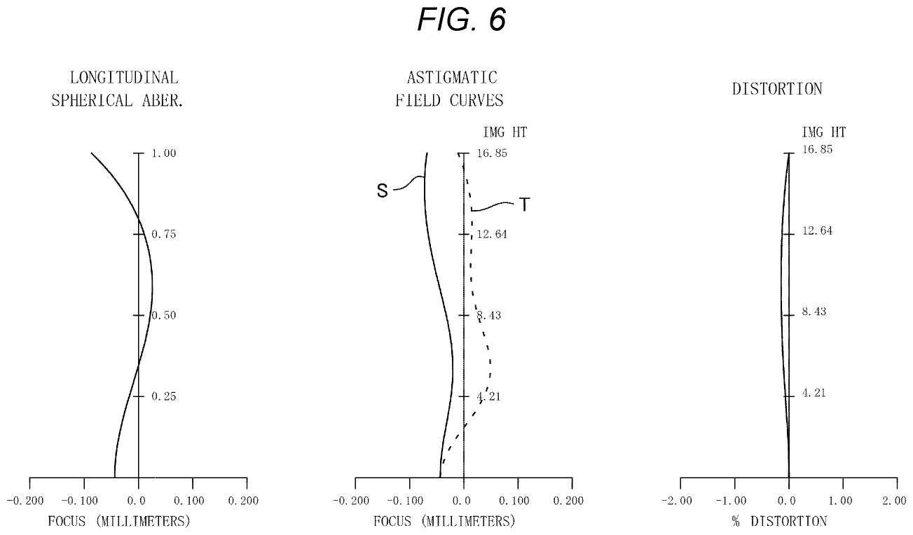

FIG. 3 is a diagram showing a coma aberration at a wide-angle end of the projection optical system 3A. FIG. 4 is a diagram showing a coma aberration at a telephoto end of the projection optical system 3A. FIG. 5 is a diagram showing a spherical aberration, an astigmatism, and a distortion at the wide-angle end of the projection optical system 3A. FIG. 6 is a diagram showing a spherical aberration, an astigmatism, and a distortion at the telephoto end of the projection optical system 3A. In the aberration diagrams, “G” represents an aberration at a wavelength of 550.0 nm, “R” represents an aberration at a wavelength of 620.0 nm, “B” represents an aberration at a wavelength of 470.0 nm, “S” represents a sagittal image plane at a wavelength of 550.0 nm, and “T” represents a tangential image plane at a wavelength of 550.0 nm. As shown in FIGS. 3 to 6, various aberrations are prevented in the projection optical system 3A according to the embodiment.

### Second Embodiment

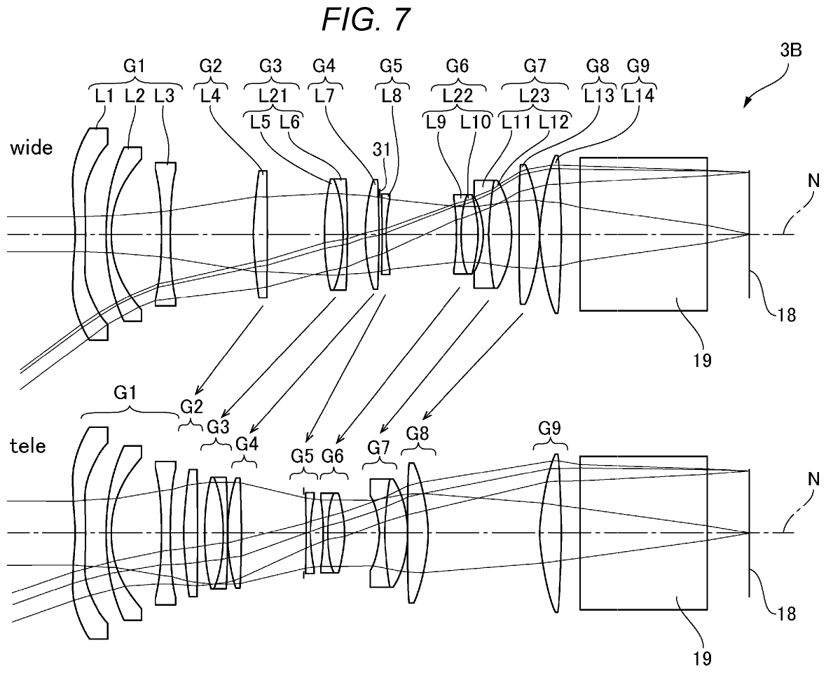

FIG. 7 is a ray diagram of a projection optical system 3B according to a second embodiment. As shown in FIG. 7, the projection optical system 3B includes, in an order from a magnification side to a reduction side, the first lens group G1 having negative power, the second lens group G2 having positive power, the third lens group G3 having positive power, the fourth lens group G4 having positive power, the fifth lens group G5 having negative power, the sixth lens group G6 having negative power, the seventh lens group G7 having negative power, the eighth lens group G8 having positive power, and the ninth lens group G9 having positive power. The projection optical system 3B includes the aperture stop 31 disposed between the fourth lens group G4 and the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes one lens L4. The lens L4 has positive power. The lens L4 is a meniscus lens. The lens L4 has a convex shape on a magnification side surface thereof and a concave shape on a reduction side surface thereof. The third lens group G3 includes two lenses L5 to L6. The lenses L5 to L6 are disposed in this order from the magnification side to the reduction side. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The fourth lens group G4 includes one lens L7. The lens L7 has positive power. The lens L7 has convex shapes on magnification side and reduction side surfaces thereof.

The fifth lens group G5 includes one lens L8. The lens L8 has negative power. The lens L8 has concave shapes on magnification side and reduction side surfaces thereof. The sixth lens group G6 includes two lenses L9 to L10. The lenses L9 to L10 are disposed in this order from the magnification side to the reduction side. The lens L9 has negative power. The lens L9 has concave shapes on magnification side and reduction side surfaces thereof. The lens L10 has positive power. The lens L10 has convex shapes on magnification side and reduction side surfaces thereof. The lens L9 and the lens L10 are cemented to form the cemented lens L22.

The seventh lens group G7 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form a cemented lens L23.

The eighth lens group G8 includes one lens L13. The lens L13 has positive power. The lens L13 has convex shapes on magnification side and reduction side surfaces thereof. The ninth lens group G9 includes one lens L14. The lens L14 has positive power. The lens L14 has convex shapes on magnification side and reduction side surfaces thereof.

Here, the lens L1 is an aspherical lens having aspherical shapes on magnification side and reduction side surfaces thereof. The lenses L2 to L14 are spherical lenses having spherical shapes on magnification side and reduction side surfaces thereof.

In the projection optical system 3B, a reduction side from the lens L14 of the ninth lens group G9 is telecentric.

The projection optical system 3B is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3B is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L14) is LL, a maximum image height of the liquid crystal panel 18 is IH, a composite focal length of all the lenses (the seven lenses L1 to L7), which are disposed on the magnification side with respect to the aperture stop 31, at the wide-angle end is F1, a focal length of the fifth lens group G5 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3B is as follows.

| FNo (wide-angle end to | 2.45-2.77 | |
|---|---|---|
| telephoto end) | | |
| Fw | 23.520 | mm |
| Ft | 48.960 | mm |
| Z | 2.082 | |
| BF | 52.487 | mm |
| LL | 136.000 | mm |
| IH | 16.850 | mm |
| F1 | 20.612 | mm |
| Fgs | −75.56 | mm |
| Fg1 | −31.388 | mm |
| Fg2 | 112.931 | mm |
| Fg3 | 74.199 | mm |

| Reference | Surface | | | | |
|---|---|---|---|---|---|
| numeral | number | R | D | Nd | Vd |
| S | 0 | 1.00E+18 | 2400.0000 | | |
| L01 | 1* | −36.9127 | 2.7751 | 1.53504 | 55.711 |
| | 2* | −71.5601 | 5.7197 | | |
| L02 | 3 | 57.9884 | 1.5000 | 1.48749 | 70.236 |
| | 4 | 28.0798 | 14.1196 | | |
| L03 | 5 | −87.1212 | 2.3841 | 1.53996 | 59.463 |
| | 6 | 97.1945 | Variable | | |
| | | | interval 1 | | |
| L04 | 7 | 86.8774 | 3.9056 | 1.84666 | 23.778 |
| | 8 | 856.3821 | Variable | | |
| | | | interval 2 | | |
| L05 | 9 | 66.6678 | 5.3230 | 1.80100 | 34.967 |
| L06 | 10 | −44.9629 | 1.2000 | 1.84666 | 23.778 |
| | 11 | −337.0690 | Variable | | |
| | | | interval 3 | | |
| L07 | 12 | 45.4127 | 3.8597 | 1.60311 | 60.641 |
| | 13 | −669.1450 | Variable | | |
| | | | interval 4 | | |
| 31 | 14 | 1.00E+18 | 0.3335 | | |
| L08 | 15 | −366.5520 | 1.2000 | 1.51633 | 64.142 |
| | 16 | 43.8697 | Variable | | |
| | | | interval 5 | | |
| L09 | 17 | −62.1975 | 1.2000 | 1.78470 | 26.291 |
| L10 | 18 | 35.1592 | 4.7046 | 1.49700 | 81.546 |
| | 19 | −35.1302 | Variable | | |
| | | | interval 6 | | |
| L11 | 20 | −21.4219 | 1.6188 | 1.71736 | 29.518 |
| L12 | 21 | 76.2695 | 6.4237 | 1.49700 | 81.546 |
| | 22 | −28.3796 | Variable | | |
| | | | interval 7 | | |
| L13 | 23 | 363.1262 | 5.7789 | 1.80810 | 22.761 |
| | 24 | −47.6668 | Variable | | |
| | | | interval 8 | | |
| L14 | 25 | 55.8929 | 6.1212 | 1.49700 | 81.546 |
| | 26 | −211.6680 | 5.1000 | | |
| 19 | 27 | 1.00E+18 | 35.5400 | 1.51680 | 64.198 |
| | 28 | 1.00E+18 | 0.0000 | | |
| 18 | 29 | 1.00E+18 | 11.8300 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 23.1700 | 3.9300 |
| Variable interval 2 | 16.0300 | 2.1800 |
| Variable interval 3 | 4.9100 | 0.1000 |
| Variable interval 4 | 0.6300 | 18.1300 |
| Variable interval 5 | 19.9200 | 3.9800 |
| Variable interval 6 | 1.5000 | 9.7500 |
| Variable interval 7 | 1.9100 | 0.1000 |
| Variable interval 8 | 0.1000 | 30.0000 |

Each aspherical coefficient is as follows.

| Surface number | 1 | 2 |
|---|---|---|
| R | −36.9127 | −71.5601 |
| Conic constant (K) | −20.9334 | −100.0000 |
| 4th-order | 3.911140E−05 | 5.141869E−05 |
| coefficient | | |
| 6th-order | −8.439868E−08 | −1.025969E−07 |
| coefficient | | |
| 8th-order | 1.308602E−10 | 1.483457E−10 |
| coefficient | | |
| 10th-order | −1.294703E−13 | −1.324732E−13 |
| coefficient | | |
| 12th-order | 7.489504E−17 | 7.782971E−17 |
| coefficient | | |
| 14th-order | −1.943793E−20 | −2.806663E−20 |
| coefficient | | |

Here, the projection optical system 3B according to the embodiment satisfies conditional expressions (1) to (8) similarly to the projection optical system 3A according to the first embodiment.

In the embodiment, variables are as below.

| | | |
|---|---|---|
| F1 | 20.612 | mm |
| Fw | 23.520 | mm |

Therefore, F1/Fw=0.876, which satisfies the conditional expression (1).

In the embodiment, variables are as below.

| | | |
|---|---|---|
| Fgs | −75.56 | mm |
| Fw | 23.520 | mm |

Therefore, Fgs/Fw=−3.21, which satisfies the conditional expression (2).

In the embodiment, variables are as below.

| | | |
|---|---|---|
| Fw | 23.520 | mm |
| Ft | 48.960 | mm |
| LL | 136.000 | mm |
| IH | 16.850 | mm |

Therefore, (LL/IH)/(Ft/Fw)=3.877, which satisfies the conditional expression (3).

In the embodiment, variables are as below.

| | | |
|---|---|---|
| Fw | 23.520 | mm |
| Fg1 | −31.388 | mm |

Therefore, Fg1/Fw=−1.33, which satisfies the conditional expression (4).

In the embodiment, variables are as below.

| | | |
|---|---|---|
| Fw | 23.520 | mm |
| Fg2 | 112.931 | mm |

Therefore, Fg2/Fw=4.801, which satisfies the conditional expression (5).

In the embodiment, variables are as below.

| | | |
|---|---|---|
| Fg2 | 112.931 | mm |
| Fg3 | 74.199 | mm |

Therefore, Fg2/Fg3=1.522, which satisfies the conditional expression (6).

In the embodiment, variables are as below.

| | |
|---|---|
| Nd1 | 1.801 |
| Nd2 | 1.847 |
| Vd1 | 34.967 |
| Vd2 | 23.778 |

Therefore, |(Nda×Vd1_−(Nd2×Vd2)|=19.067, which satisfies the conditional expression (7).

In the embodiment, Nd2=1.847, which satisfies the conditional expression (8).

### Effects

According to the embodiment, since the projection optical system 3B has a configuration similar to that of the projection optical system 3A according to the first embodiment, effects similar to those of the projection optical system 3A according to the first embodiment can be obtained.

Since the projection optical system 3B according to the embodiment satisfies the conditional expressions (1) to (8), effects similar to those of the projection optical system 3A according to the first embodiment can be obtained.

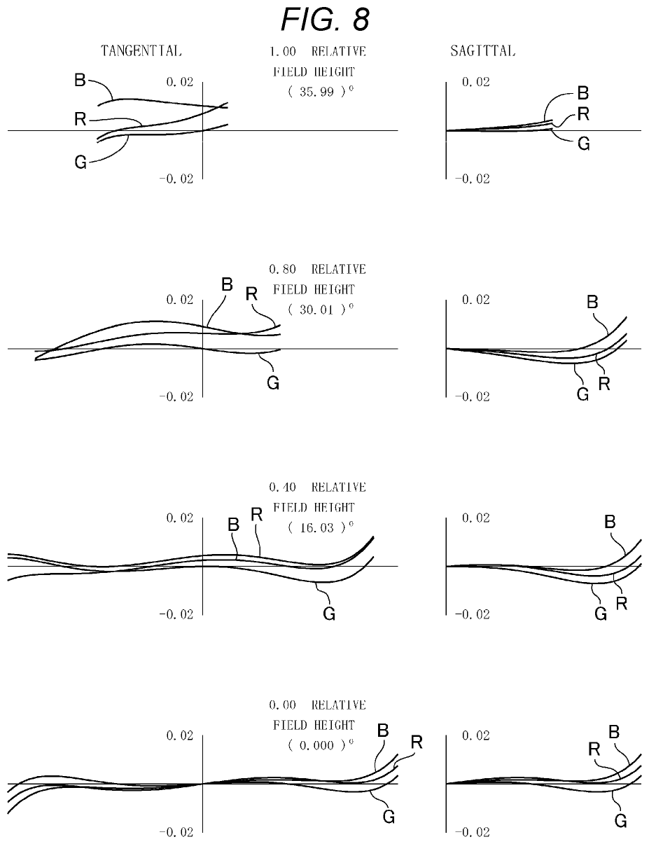

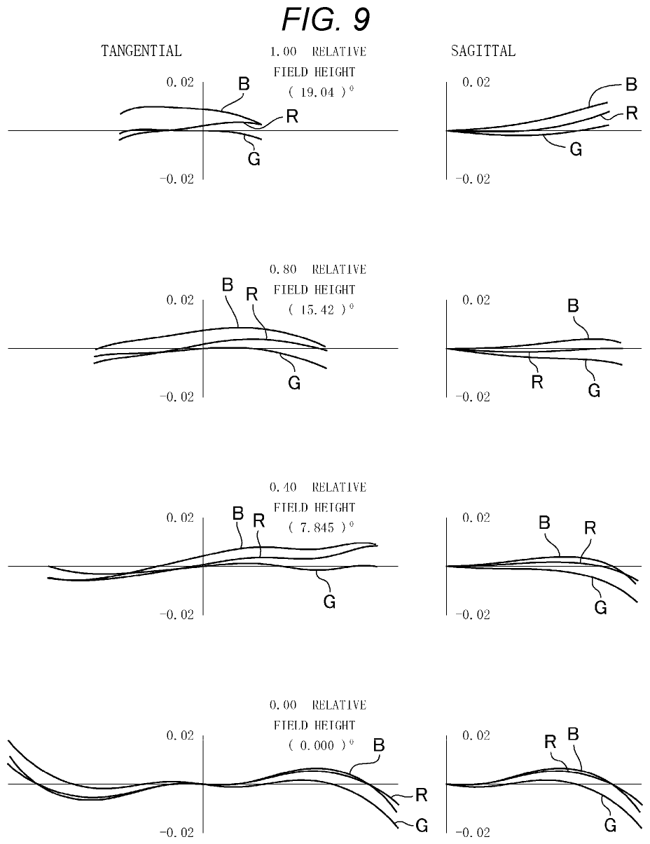

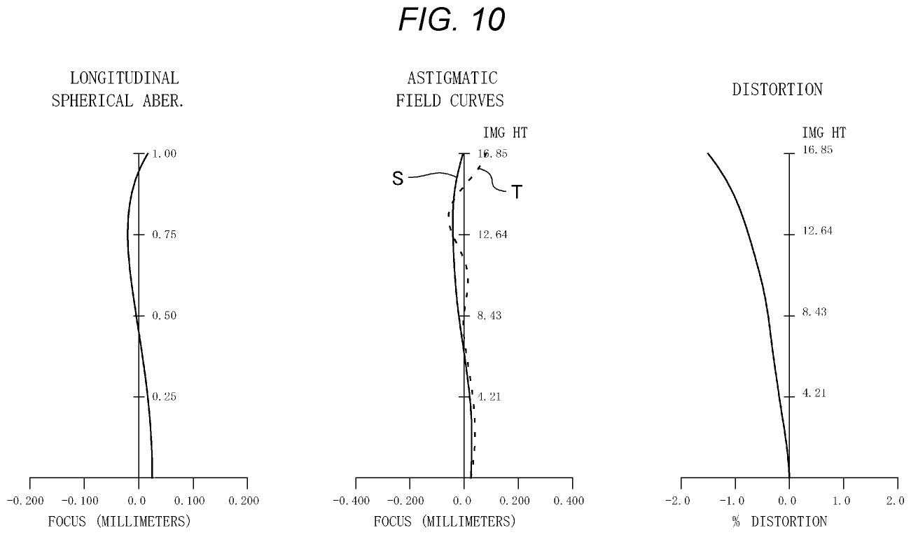

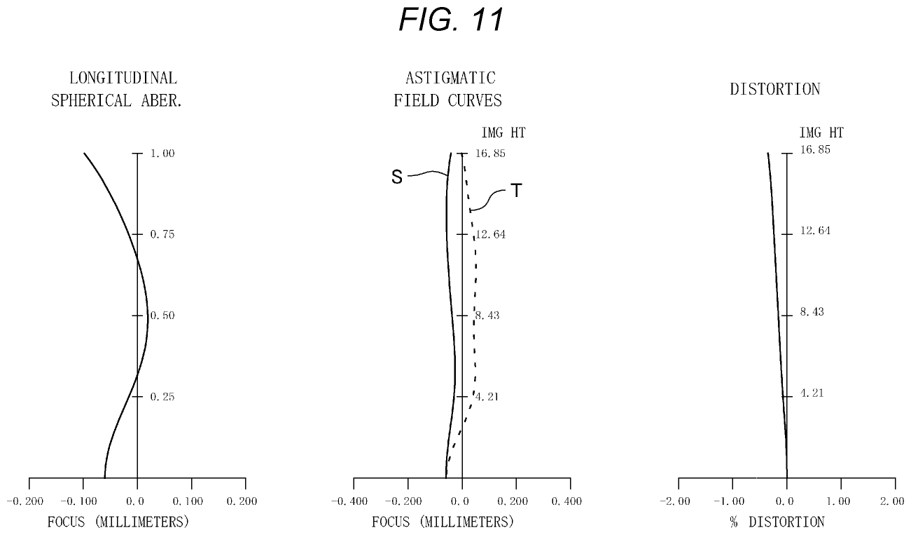

FIG. 8 is a diagram showing a coma aberration at a wide-angle end of the projection optical system 3B. FIG. 9 is a diagram showing a coma aberration at a telephoto end of the projection optical system 3B. FIG. 10 is a diagram showing a spherical aberration, an astigmatism, and a distortion at the wide-angle end of the projection optical system 3B. FIG. 11 is a diagram showing a spherical aberration, an astigmatism, and a distortion at the telephoto end of the projection optical system 3B. As shown in FIGS. 8 to 11, various aberrations are prevented in the projection optical system 3B according to the embodiment.

### Third Embodiment

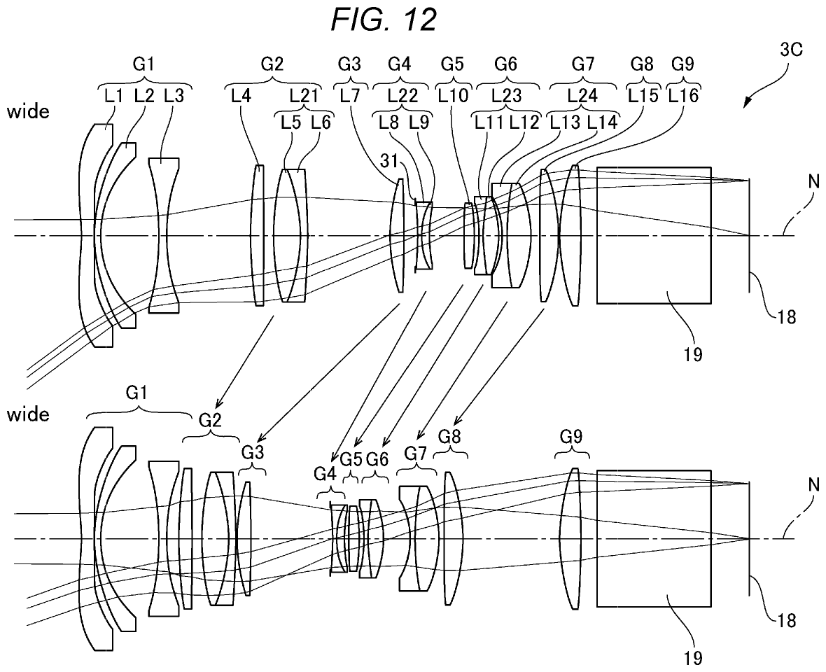

FIG. 12 is a ray diagram of a projection optical system 3C according to a third embodiment. As shown in FIG. 12, the projection optical system 3C includes, in an order from a magnification side to a reduction side, the first lens group G1 having negative power, the second lens group G2 having positive power, the third lens group G3 having positive power, the fourth lens group G4 having negative power, the fifth lens group G5 having positive power, the sixth lens group G6 having negative power, the seventh lens group G7 having negative power, the eighth lens group G8 having positive power, and the ninth lens group G9 having positive power. The projection optical system 3C includes the aperture stop 31 disposed between the third lens group G3 and the fourth lens group G4.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes three lenses L4 to L6. The lenses L4 to L6 are disposed in this order from the magnification side to the reduction side. The lens L4 has positive power. The lens L4 has convex shapes on magnification side and reduction side surfaces thereof. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The third lens group G3 includes one lens L7. The lens L7 has positive power. The lens L7 has convex shapes on magnification side and reduction side surfaces thereof.

The fourth lens group G4 includes two lenses L8 to L9. The lenses L8 to L9 are disposed in this order from the magnification side to the reduction side. The lens L8 has negative power. The lens L8 has concave shapes on magnification side and reduction side surfaces thereof. The lens L9 has positive power. The lens L9 is a meniscus lens. The lens L9 has a convex shape on a magnification side surface thereof and a concave shape on a reduction side surface thereof. The lens L8 and the lens L9 are cemented to form a cemented lens L22.

The fifth lens group G5 includes one lens L10. The lens L10 has positive power. The lens L8 has convex shapes on magnification side and reduction side surfaces thereof.

The sixth lens group G6 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form a cemented lens L23.

The seventh lens group G7 includes two lenses L13 to L14. The lenses L13 to L14 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form a cemented lens L24.

The eighth lens group G8 includes one lens L15. The lens L15 has positive power. The lens L15 has convex shapes on magnification side and reduction side surfaces thereof. The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3C, a reduction side from the lens L16 of the ninth lens group G9 is telecentric.

The projection optical system 3C is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3C is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the seven lenses L1 to L7), which are disposed on the magnification side with respect to the aperture stop 31, at the wide-angle end is F1, a focal length of the fourth lens group G4 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3C is as follows.

| FNo (wide-angle end to | 2.40-3.11 | |
|---|---|---|
| telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 25.738 | mm |
| Fgs | −49.09 | mm |
| Fg1 | −29.463 | mm |
| Fg2 | 53.670 | mm |
| Fg3 | 69.958 | mm |

| Reference | Surface | | | | |
|---|---|---|---|---|---|
| numeral | number | R | D | Nd | Vd |
| S | 0 | 1.00E+18 | 2400.0000 | | |
| L01 | 1* | −42.2699 | 4.0000 | 1.53504 | 55.711 |
| | 2* | −87.7601 | 0.1000 | | |
| L02 | 3 | 51.6807 | 1.8158 | 1.48749 | 70.236 |
| | 4 | 31.4124 | 18.0875 | | |
| L03 | 5 | −82.2390 | 2.5000 | 1.56883 | 56.364 |
| | 6 | 58.6579 | Variable | | |
| | | | interval 1 | | |
| L04 | 7 | 137.0761 | 4.0000 | 1.84666 | 23.778 |
| | 8 | 2014.7060 | 3.2905 | | |
| L05 | 9 | 80.1117 | 8.3144 | 1.80100 | 34.967 |
| L06 | 10 | −50.7030 | 2.3100 | 1.84666 | 23.778 |
| | 11 | −190.1780 | Variable | | |
| | | | interval 2 | | |
| L07 | 12 | 51.2319 | 4.4907 | 1.62299 | 58.166 |
| | 13 | −289.1790 | Variable | | |
| | | | interval 3 | | |
| 31 | 14 | 1.00E+18 | 0.7652 | | |
| L08 | 15 | −73.8655 | 1.2000 | 1.57135 | 52.952 |
| L09 | 16 | 21.4786 | 2.4968 | 1.62041 | 60.290 |
| | 17 | 42.3981 | Variable | | |
| | | | interval 4 | | |
| L10 | 18 | 296.9137 | 3.1997 | 1.60311 | 60.641 |
| | 19 | −48.3909 | Variable | | |
| | | | interval 5 | | |
| L11 | 20 | −39.3149 | 1.2000 | 1.72825 | 28.461 |
| L12 | 21 | 59.4910 | 5.2426 | 1.49700 | 81.546 |
| | 22 | −31.0013 | Variable | | |
| | | | interval 6 | | |
| L13 | 23 | −24.5907 | 1.4550 | 1.71736 | 29.518 |
| L14 | 24 | 72.1540 | 7.5766 | 1.49700 | 81.546 |
| | 25 | −36.7772 | Variable | | |
| | | | interval 7 | | |
| L15 | 26 | 438.6982 | 5.9815 | 1.80810 | 22.761 |
| | 27 | −51.2980 | Variable | | |
| | | | interval 8 | | |
| L16 | 28 | 59.1826 | 6.6496 | 1.49700 | 81.546 |
| | 29 | −240.1480 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8300 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 26.1400 | 3.9900 |
| Variable interval 2 | 25.6800 | 0.4000 |
| Variable interval 3 | 4.1000 | 25.7800 |
| Variable interval 4 | 10.8800 | 1.0000 |
| Variable interval 5 | 1.4300 | 2.2500 |
| Variable interval 6 | 0.8000 | 7.4100 |
| Variable interval 7 | 2.6800 | 1.7900 |
| Variable interval 8 | 0.3900 | 29.4800 |

Each aspherical coefficient is as follows.

| Surface number | 1 | 2 |
|---|---|---|
| R | −42.2699 | −87.7601 |
| Conic constant (K) | −17.7508 | −100.0000 |
| 4th-order | 2.220515E−05 | 2.868826E−05 |
| coefficient | | |
| 6th-order | −3.435636E−08 | −3.754573E−08 |
| coefficient | | |
| 8th-order | 3.817514E−11 | 2.613379E−11 |
| coefficient | | |
| 10th-order | −2.647810E−14 | 5.142597E−15 |
| coefficient | | |
| 12th-order | 1.056591E−17 | −1.849835E−17 |
| coefficient | | |
| 14th-order | −1.819882E−21 | 8.139862E−21 |
| coefficient | | |

Here, the projection optical system 3C according to the embodiment satisfies the conditional expressions (1) to (8) similarly to the projection optical system 3A according to the first embodiment.

In the embodiment, variables are as below.

| | | |
|---|---|---|
| F1 | 25.738 | mm |
| Fw | 23.520 | mm |

Therefore, F1/Fw=1.094, which satisfies the conditional expression (1).

In the embodiment, variables are as below.

| | | |
|---|---|---|
| Fgs | −49.09 | mm |
| Fw | 23.520 | mm |

Therefore, Fgs/Fw=−2.09, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −29.463 | mm |

Therefore, Fg1/Fw=−1.25, which satisfies the conditional expression (4).

In the embodiment, variables are as below.

| | | |
|---|---|---|
| Fw | 23.520 | mm |
| Fg2 | 53.670 | mm |

Therefore, Fg2/Fw=2.282, which satisfies the conditional expression (5).

In the embodiment, variables are as below.

| | | |
|---|---|---|
| Fg2 | 53.670 | mm |
| Fg3 | 69.958 | mm |

Therefore, Fg2/Fg3=0.767, which satisfies the conditional expression (6).

In the embodiment, variables are as below.

| | |
|---|---|
| Nd1 | 1.801 |
| Nd2 | 1.847 |
| Vd1 | 34.967 |
| Vd2 | 23.778 |

Therefore, |(Nda×Vd1_−(Nd2×Vd2)|=19.067, which satisfies the conditional expression (7).

In the embodiment, Nd2=1.847, which satisfies the conditional expression (8).

### Effects

According to the embodiment, since the projection optical system 3C has a configuration similar to that of the projection optical system 3A according to the first embodiment, effects similar to those of the projection optical system 3A according to the first embodiment can be obtained.

Since the projection optical system 3C according to the embodiment satisfies the conditional expressions (1) to (8), effects similar to those of the projection optical system 3A according to the first embodiment can be obtained.

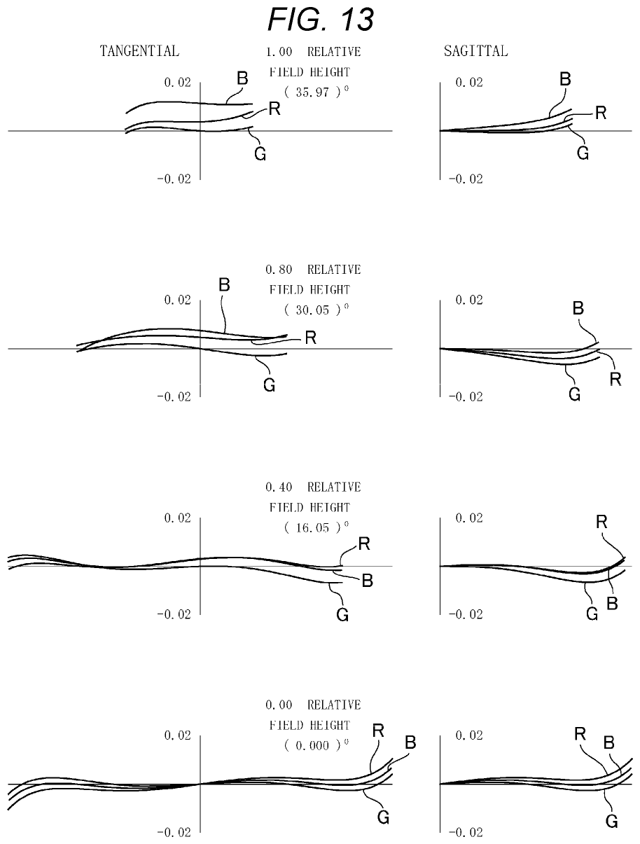

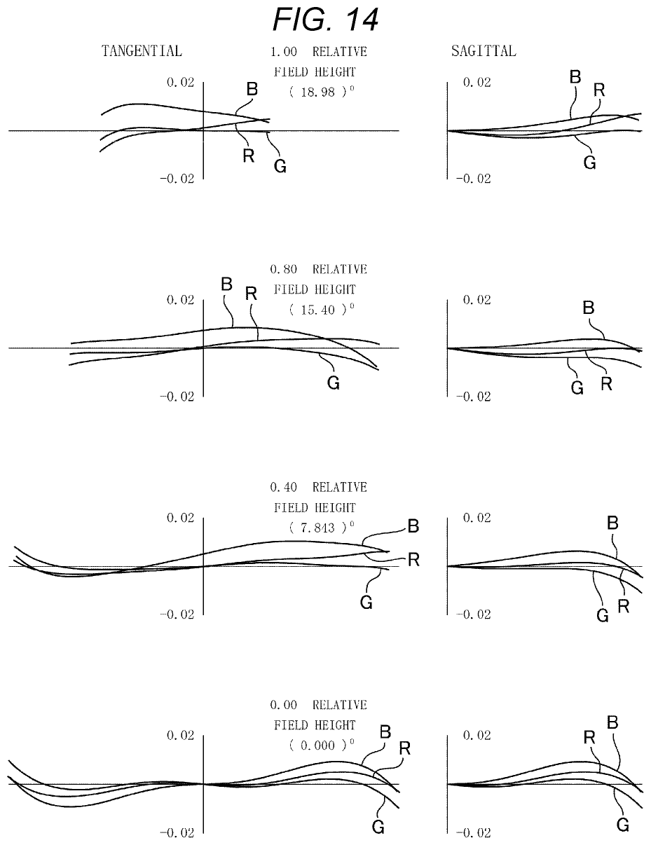

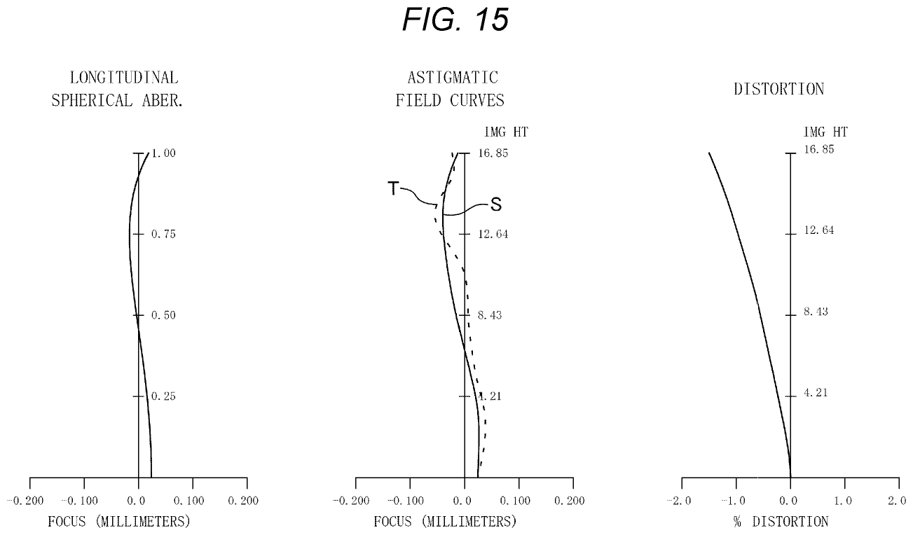

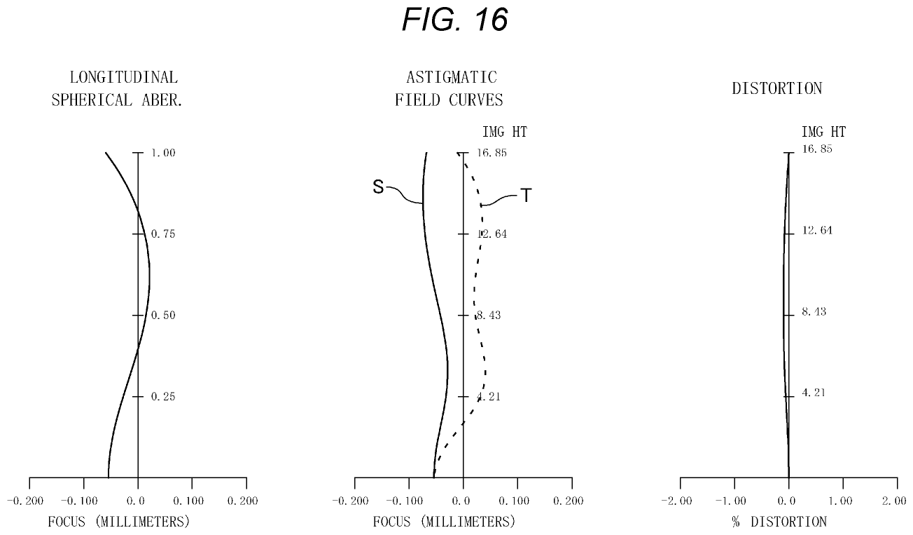

FIG. 13 is a diagram showing a coma aberration at a wide-angle end of the projection optical system 3C. FIG. 14 is a diagram showing a coma aberration at a telephoto end of the projection optical system 3C. FIG. 15 is a diagram showing a spherical aberration, an astigmatism, and a distortion at the wide-angle end of the projection optical system 3C. FIG. 16 is a diagram showing a spherical aberration, an astigmatism, and a distortion at the telephoto end of the projection optical system 3C. As shown in FIGS. 14 to 16, various aberrations are prevented in the projection optical system 3C according to the embodiment.

### Fourth Embodiment

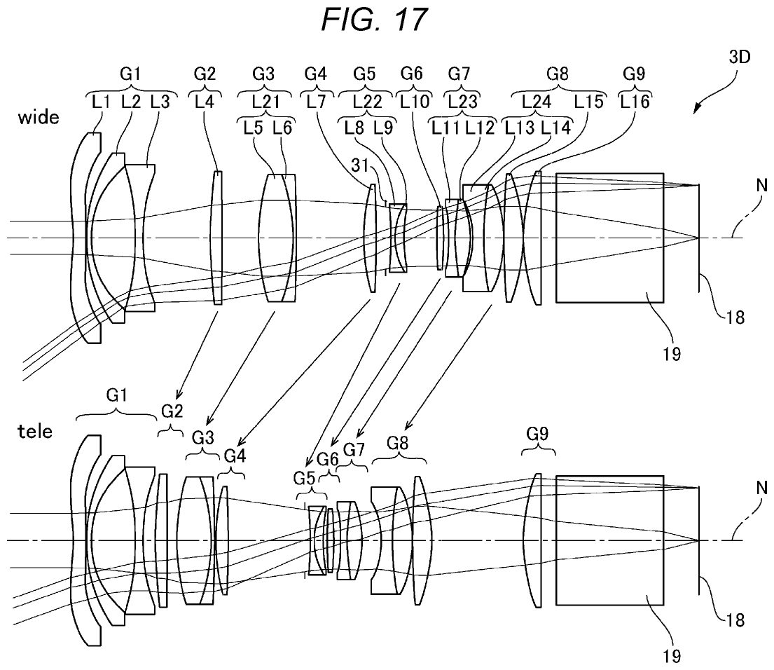

FIG. 17 is a ray diagram of a projection optical system 3D according to a fourth embodiment. As shown in FIG. 17, the projection optical system 3D includes, in an order from a magnification side to a reduction side, the first lens group G1 having negative power, the second lens group G2 having positive power, the third lens group G3 having positive power, the fourth lens group G4 having positive power, the fifth lens group G5 having negative power, the sixth lens group G6 having positive power, the seventh lens group G7 having positive power, the eighth lens group G8 having positive power, and the ninth lens group G9 having positive power. The projection optical system 3D includes the aperture stop 31 disposed between the fourth lens group G4 and the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes one lens L4. The lens L4 has positive power. The lens L4 has convex shapes on magnification side and reduction side surfaces thereof. The third lens group G3 includes two lenses L5 to L6. The lens L5 (positive lens, first lens) has positive power. The lens L5 has convex shapes on magnification side and reduction side surfaces thereof. The lens L6 has negative power. The lens L6 (negative lens, second lens) is a meniscus lens. The lens L6 has a concave shape on a magnification side surface thereof and a convex shape on a reduction side surface thereof. The lens L5 and the lens L6 are cemented to form a cemented lens L21. The fourth lens group G4 includes one lens L7. The lens L7 has positive power. The lens L7 has convex shapes on magnification side and reduction side surfaces thereof.

The fifth lens group G5 includes two lenses L8 to L9. The lenses L8 to L9 are disposed in this order from the magnification side to the reduction side. The lens L8 has negative power. The lens L8 has concave shapes on magnification side and reduction side surfaces thereof. The lens L9 has positive power. The lens L9 is a meniscus lens. The lens L9 has a convex shape on a magnification side surface thereof and a concave shape on a reduction side surface thereof. The lens L8 and the lens L9 are cemented to form a cemented lens L22. The sixth lens group G6 includes one lens L10. The lens L10 has positive power. The lens L10 has convex shapes on magnification side and reduction side surfaces thereof.

The seventh lens group G7 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form a cemented lens L23.

The eighth lens group G8 includes three lenses L13 to L15. The lenses L13 to L15 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form a cemented lens L24. The lens L15 has positive power. The lens L15 has convex shapes on magnification side and reduction side surfaces thereof.

The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3D, a reduction side from the lens L16 of the ninth lens group G9 is telecentric.

The projection optical system 3D is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3D is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the seven lenses L1 to L7), which are disposed on the magnification side with respect to the aperture stop 31, at the wide-angle end is F1, a focal length of the fifth lens group G5 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3D is as follows.

| FNo (wide-angle end | 2.20-2.90 | |
|---|---|---|
| to telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 27.617 | mm |
| Fgs | −54.79 | mm |
| Fg1 | −30.519 | mm |
| Fg2 | 156.210 | mm |
| Fg3 | 79.349 | mm |

| Reference | Surface | | | | |
|---|---|---|---|---|---|
| numeral | number | R | D | Nd | Vd |
| S | 0 | 1.00E+18 | 2400.0000 | | |
| L01 | 1* | −47.6547 | 4.0000 | 1.53504 | 55.711 |
| | 2* | −95.3407 | 0.1000 | | |
| L02 | 3 | 47.6647 | 1.6450 | 1.48749 | 70.236 |
| | 4 | 29.9552 | 14.7864 | | |
| L03 | 5 | −75.2274 | 2.5000 | 1.57135 | 52.952 |
| | 6 | 58.6628 | Variable | | |
| | | | interval 1 | | |
| L04 | 7 | 170.7181 | 4.0000 | 1.84666 | 23.778 |
| | 8 | −604.2360 | Variable | | |
| | | | interval 2 | | |
| L05 | 9 | 76.6923 | 11.2189 | 1.80100 | 34.967 |
| L06 | 10 | −53.5985 | 1.2000 | 1.84666 | 23.778 |
| | 11 | −270.0010 | Variable | | |
| | | | interval 3 | | |
| L07 | 12 | 56.3570 | 4.3176 | 1.62299 | 58.166 |
| | 13 | −252.2550 | Variable | | |
| | | | interval 4 | | |
| 31 | 14 | 1.00E+18 | 1.9787 | | |
| L08 | 15 | −81.1194 | 1.2000 | 1.57135 | 52.952 |
| L09 | 16 | 19.5777 | 3.0074 | 1.60311 | 60.641 |
| | 17 | 48.0177 | Variable | | |
| | | | interval 5 | | |
| L10 | 18 | 270.4008 | 2.1261 | 1.62041 | 60.290 |
| | 19 | −92.4801 | Variable | | |
| | | | interval 6 | | |
| L11 | 20 | −50.7571 | 2.0150 | 1.71736 | 29.518 |
| L12 | 21 | 54.9961 | 5.4964 | 1.49700 | 81.546 |
| | 22 | −29.3709 | Variable | | |
| | | | interval 7 | | |
| L13 | 23 | −24.5998 | 3.5783 | 1.71736 | 29.518 |
| L14 | 24 | 79.6962 | 6.9588 | 1.49700 | 81.546 |
| | 25 | −37.7482 | 0.1000 | | |
| L15 | 26 | 239.4948 | 6.0629 | 1.80810 | 22.761 |
| | 27 | −55.2129 | Variable | | |
| | | | interval 8 | | |
| L16 | 28 | 54.3293 | 6.1172 | 1.49700 | 81.546 |
| | 29 | −636.2420 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8624 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 22.4700 | 4.6100 |
| Variable interval 2 | 10.4400 | 1.4600 |
| Variable interval 3 | 22.5200 | 0.4000 |
| Variable interval 4 | 2.4600 | 25.0000 |
| Variable interval 5 | 10.9500 | 1.5000 |
| Variable interval 6 | 1.7900 | 2.1400 |
| Variable interval 7 | 0.6400 | 6.2600 |
| Variable interval 8 | 0.1000 | 30.0000 |

Each aspherical coefficient is as follows.

| Surface number | 1 | 2 |
|---|---|---|
| R | −47.6547 | −95.3407 |
| Conic constant (K) | −19.3545 | −100.0000 |
| 4th-order | 2.124963E−05 | 2.550879E−05 |
| coefficient | | |
| 6th-order | −3.169335E−08 | −3.151684E−08 |
| coefficient | | |
| 8th-order | 3.367682E−11 | 1.534206E−11 |
| coefficient | | |
| 10th-order | −2.146961E−14 | 1.748011E−14 |
| coefficient | | |
| 12th-order | 7.688045E−18 | −2.621090E−17 |
| coefficient | | |
| 14th-order | −1.002380E−21 | 1.100578E−20 |
| coefficient | | |

Here, the projection optical system 3D according to the embodiment satisfies the conditional expressions (1) to (8) similarly to the projection optical system 3A according to the first embodiment.

In the embodiment, variables are as below.

| | | |
|---|---|---|
| F1 | 27.617 | mm |
| Fw | 23.520 | mm |

Therefore, F1/Fw=1.174, which satisfies the conditional expression (1).

In the embodiment, variables are as below.

| | | |
|---|---|---|
| Fgs | −54.79 | mm |
| Fw | 23.520 | mm |

Therefore, Fgs/Fw=−2.33, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −30.519 | mm |

Therefore, Fg1/Fw=−1.30, which satisfies the conditional expression (4).

In the embodiment, variables are as below.

| | | |
|---|---|---|
| Fw | 23.520 | mm |
| Fg2 | 156.210 | mm |

Therefore, Fg2/Fw=6.642, which satisfies the conditional expression (5).

In the embodiment, variables are as below.

| | | |
|---|---|---|
| Fg2 | 156.210 | mm |
| Fg3 | 79.349 | mm |

Therefore, Fg2/Fg3=1.969, which satisfies the conditional expression (6).

In the embodiment, variables are as below.

| | |
|---|---|
| Nd1 | 1.801 |
| Nd2 | 1.847 |
| Vd1 | 34.967 |
| Vd2 | 23.778 |

Therefore, |(Nda×Vd1_−(Nd2×Vd2)|=19.067, which satisfies the conditional expression (7).

In the embodiment, Nd2=1.847, which satisfies the conditional expression (8).

### Effects

According to the embodiment, since the projection optical system 3D has a configuration similar to that of the projection optical system 3A according to the first embodiment, effects similar to those of the projection optical system 3A according to the first embodiment can be obtained.

Since the projection optical system 3D according to the embodiment satisfies the conditional expressions (1) to (8), effects similar to those of the projection optical system 3A according to the first embodiment can be obtained.

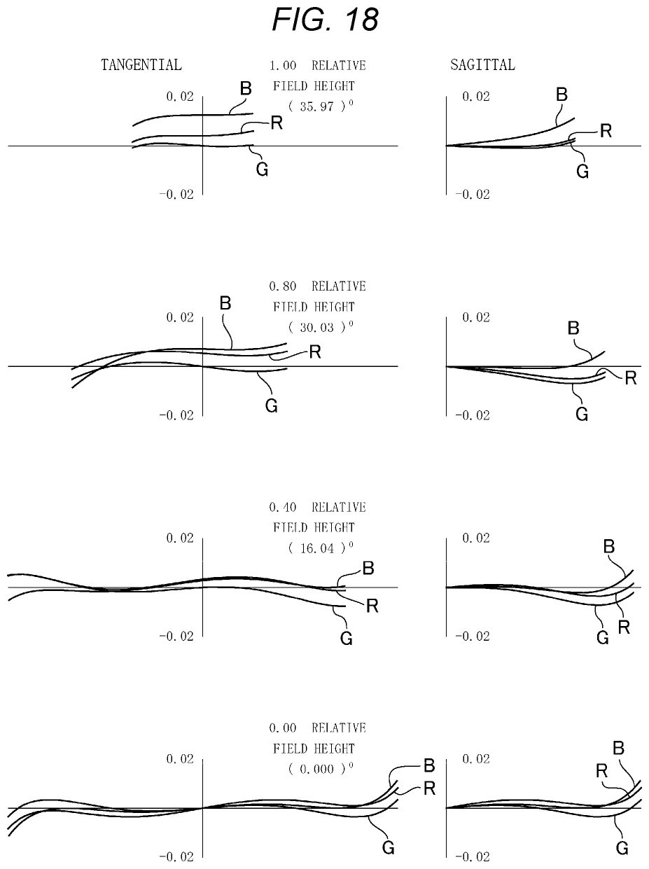

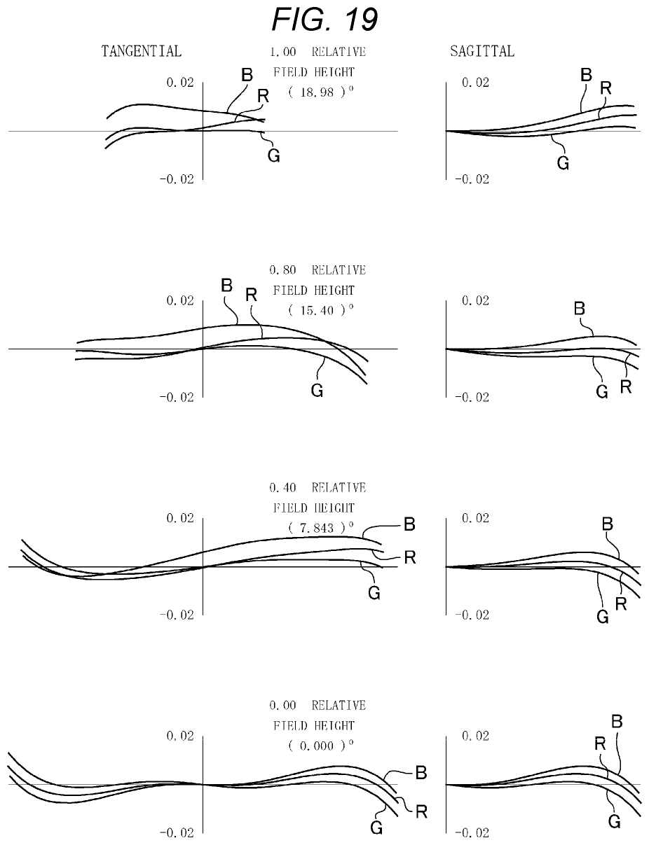

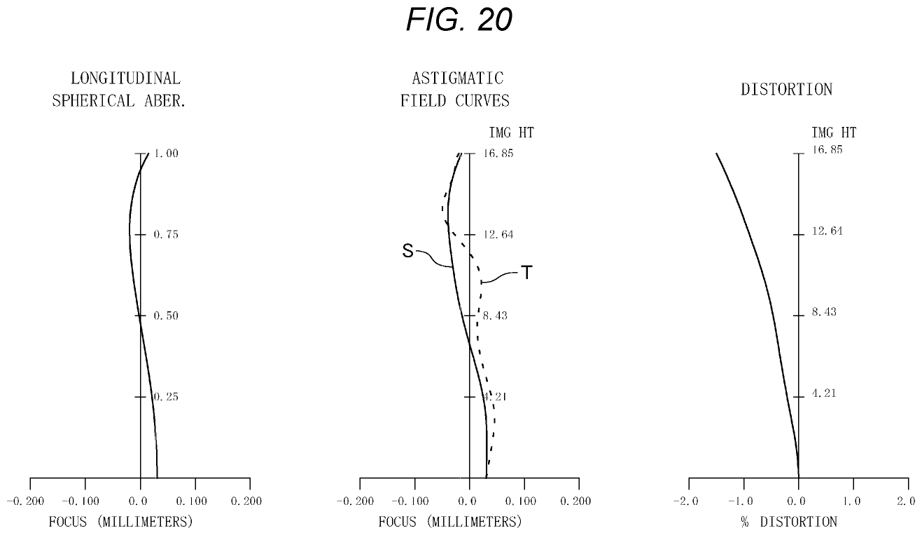

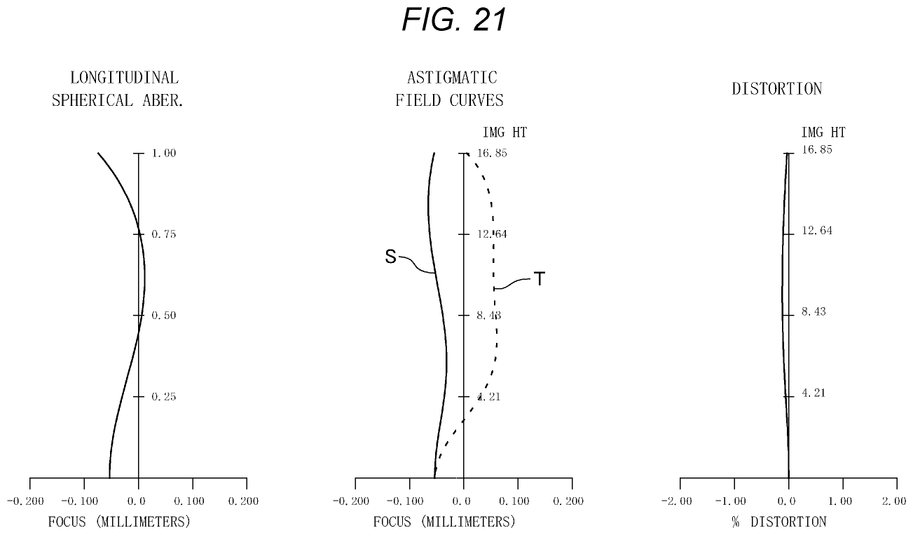

FIG. 18 is a diagram showing a coma aberration at a wide-angle end of the projection optical system 3D. FIG. 19 is a diagram showing a coma aberration at a telephoto end of the projection optical system 3D. FIG. 20 is a diagram showing a spherical aberration, an astigmatism, and a distortion at the wide-angle end of the projection optical system 3D. FIG. 21 is a diagram showing a spherical aberration, an astigmatism, and a distortion at the telephoto end of the projection optical system 3D. As shown in FIGS. 18 to 21, various aberrations are prevented in the projection optical system 3D according to the embodiment.

### Fifth Embodiment

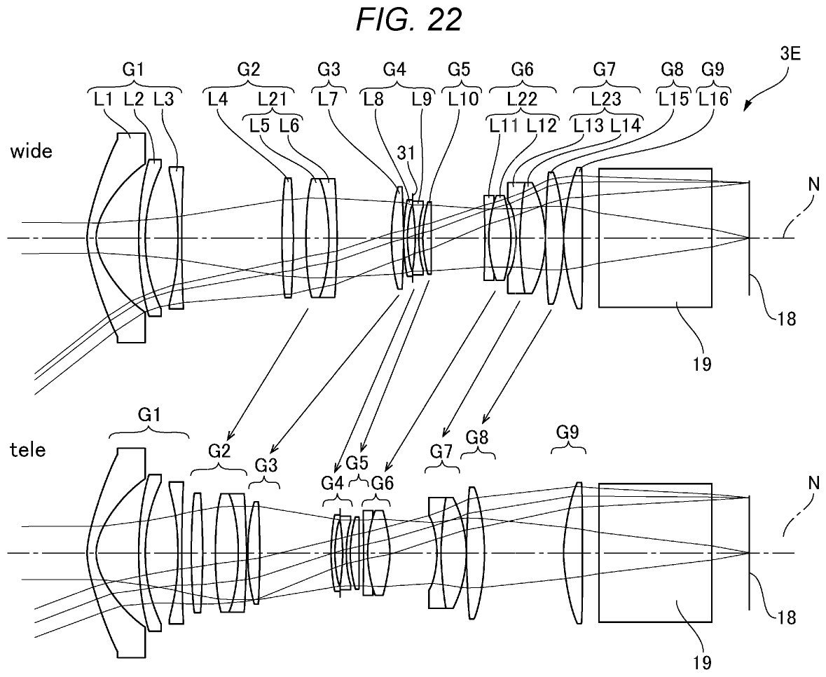

FIG. 22 is a ray diagram of a projection optical system 3E according to a fifth embodiment. As shown in FIG. 22, the projection optical system 3E includes, in an order from a magnification side to a reduction side, the first lens group G1 having negative power, the second lens group G2 having positive power, the third lens group G3 having positive power, the fourth lens group G4 having negative power, the fifth lens group G5 having positive power, the sixth lens group G6 having positive power, the seventh lens group G7 having negative power, the eighth lens group G8 having positive power, and the ninth lens group G9 having positive power. The projection optical system 3E includes the aperture stop 31 disposed between the third lens group G3 and the fourth lens group G4. More specifically, the aperture stop 31 is disposed inside the fourth lens group G4.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes three lenses L4 to L6. The lenses L4 to L6 are disposed in this order from the magnification side to the reduction side. The lens L4 has positive power. The lens L4 has convex shapes on magnification side and reduction side surfaces thereof. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The third lens group G3 includes one lens L7. The lens L7 has positive power. The lens L7 has convex shapes on magnification side and reduction side surfaces thereof.

The fourth lens group G4 includes two lenses L8 to L9. The lenses L8 to L9 are disposed in this order from the magnification side to the reduction side. The lens L8 has negative power. The lens L8 is a meniscus lens. The lens L8 has a convex shape on a magnification side surface thereof and a concave shape on a reduction side surface thereof. The lens L9 has negative power. The lens L9 has concave shapes on magnification side and reduction side surfaces thereof. The aperture stop 31 is disposed between the lens L8 and the lens L9.

The fifth lens group G5 includes one lens L10. The lens L10 has positive power. The lens L10 is a meniscus lens. The lens L10 has a convex shape on a magnification side surface thereof and a concave shape on a reduction side surface thereof.

The sixth lens group G6 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form the cemented lens L22.

The seventh lens group G7 includes two lenses L13 to L14. The lenses L13 to L14 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form the cemented lenses L23.

The eighth lens group G8 includes one lens L15. The lens L15 has positive power. The lens L15 has convex shapes on magnification side and reduction side surfaces thereof. The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3E, a reduction side from the lens L16 of the ninth lens group G9 is telecentric.

The projection optical system 3E is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3E is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the eight lenses L1 to L8), which are disposed on the magnification side with respect to the aperture stop 31, at the wide-angle end is F1, a focal length of the fourth lens group G4 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3E is as follows.

| FNo (wide-angle end | 2.35-2.87 | |
|---|---|---|
| to telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 32.653 | mm |
| Fgs | −36.21 | mm |
| Fg1 | −32.047 | mm |
| Fg2 | 60.431 | mm |
| Fg3 | 76.965 | mm |

| Reference | Surface | | | | |
|---|---|---|---|---|---|
| numeral | number | R | D | Nd | Vd |
| S | 0 | 1.00E+18 | 2390.0000 | | |
| L01 | 1* | 20.2344 | 2.8296 | 1.53504 | 55.711 |
| | 2* | 12.2674 | 13.4331 | | |
| L02 | 3 | 88.8105 | 2.0000 | 1.48749 | 70.236 |
| | 4 | 48.7683 | 10.3304 | | |
| L03 | 5 | −77.3188 | 1.2000 | 1.51584 | 63.162 |
| | 6 | 466.4574 | Variable | | |
| | | | interval 1 | | |
| L04 | 7 | 209.0301 | 3.4556 | 1.74950 | 35.333 |
| | 8 | −236.7410 | 3.9992 | | |
| L05 | 9 | 91.1441 | 7.3103 | 1.72047 | 34.708 |
| L06 | 10 | −56.6231 | 2.5000 | 1.75505 | 27.586 |
| | 11 | −251.9710 | Variable | | |
| | | | interval 2 | | |
| L07 | 12 | 56.7573 | 3.7295 | 1.60351 | 61.224 |
| | 13 | −254.2790 | Variable | | |
| | | | interval 3 | | |
| L08 | 14 | 54.2293 | 1.2000 | 1.49700 | 81.546 |
| 31 | 15 | 35.7542 | 2.5048 | | |
| L09 | 16 | −68.6194 | 1.2000 | 1.56908 | 52.653 |
| | 17 | 39.6637 | Variable | | |
| | | | interval 4 | | |
| L10 | 18 | 38.1230 | 2.7298 | 1.62226 | 59.954 |
| | 19 | 392.3853 | Variable | | |
| | | | interval 5 | | |
| L11 | 20 | −255.0530 | 1.2000 | 1.75520 | 27.580 |
| L12 | 21 | 37.2785 | 7.0694 | 1.49700 | 81.546 |
| | 22 | −37.6510 | Variable | | |
| | | | interval 6 | | |
| L13 | 23 | −26.9756 | 1.2000 | 1.72989 | 28.693 |
| L14 | 24 | 89.1130 | 7.9222 | 1.49700 | 81.546 |
| | 25 | −36.4487 | Variable | | |
| | | | interval 7 | | |
| L15 | 26 | 200.5031 | 5.7005 | 1.80810 | 22.761 |
| | 27 | −63.3241 | Variable | | |
| | | | interval 8 | | |
| L16 | 28 | 54.2581 | 5.8899 | 1.43875 | 94.661 |
| | 29 | −758.8300 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8287 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 31.5800 | 3.5000 |
| Variable interval 2 | 17.1200 | 1.0000 |
| Variable interval 3 | 0.1000 | 22.8700 |
| Variable interval 4 | 1.1900 | 0.7900 |
| Variable interval 5 | 16.8500 | 1.6700 |
| Variable interval 6 | 1.5400 | 14.3100 |
| Variable interval 7 | 0.1100 | 0.2700 |
| Variable interval 8 | 0.1000 | 24.5400 |

Each aspherical coefficient is as follows.

| Surface number | 1 | 2 |
|---|---|---|
| R | 20.2344 | 12.2674 |
| Conic constant (K) | −3.5135 | −0.8392 |
| 4th-order | −3.982168E−05 | −9.719805E−05 |
| coefficient | | |
| 6th-order | 1.763340E−07 | 3.777594E−07 |
| coefficient | | |
| 8th-order | −4.892525E−10 | −1.380270E−09 |
| coefficient | | |
| 10th-order | 9.480933E−13 | 4.491765E−12 |
| coefficient | | |
| 12th-order | −1.297511E−15 | −1.306456E−14 |
| coefficient | | |
| 14th-order | 1.242310E−18 | 3.006711E−17 |
| coefficient | | |
| 16th-order | −8.078447E−22 | −4.744525E−20 |
| coefficient | | |
| 18th-order | 3.283094E−25 | 4.385511E−23 |
| coefficient | | |
| 20th-order | −6.407864E−29 | −1.766523E−26 |
| coefficient | | |

Here, the projection optical system 3E according to the embodiment satisfies the conditional expressions (1) to (8) similarly to the projection optical system 3A according to the first embodiment.

In the embodiment, variables are as below.

| | | |
|---|---|---|
| F1 | 32.653 | mm |
| Fw | 23.520 | mm |

Therefore, F1/Fw=1.388, which satisfies the conditional expression (1).

In the embodiment, variables are as below.

| | | |
|---|---|---|
| Fgs | −36.21 | mm |
| Fw | 23.520 | mm |

Therefore, Fgs/Fw=−1.54, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −32.047 | mm |

Therefore, Fg1/Fw=−1.36, which satisfies the conditional expression (4).

In the embodiment, variables are as below.

| | | |
|---|---|---|
| Fw | 23.520 | mm |
| Fg2 | 60.431 | mm |

Therefore, Fg2/Fw=2.569, which satisfies the conditional expression (5).

In the embodiment, variables are as below.

| | | |
|---|---|---|
| Fg2 | 60.431 | mm |
| Fg3 | 76.965 | mm |

Therefore, Fg2/Fg3=0.785, which satisfies the conditional expression (6).

In the embodiment, variables are as below.

| | |
|---|---|
| Nd1 | 1.720 |
| Nd2 | 1.755 |
| Vd1 | 34.708 |
| Vd2 | 27.586 |

Therefore, |(Nd1×Vd1)−(Nd2×Vd2)|=11.300, which satisfies the conditional expression (7).

In the embodiment, Nd2=1.755, which satisfies the conditional expression (8).

### Effects

According to the embodiment, since the projection optical system 3E has a configuration similar to that of the projection optical system 3A according to the first embodiment, effects similar to those of the projection optical system 3A according to the first embodiment can be obtained.

Since the projection optical system 3E according to the embodiment satisfies the conditional expressions (1) to (8), effects similar to those of the projection optical system 3A according to the first embodiment can be obtained.

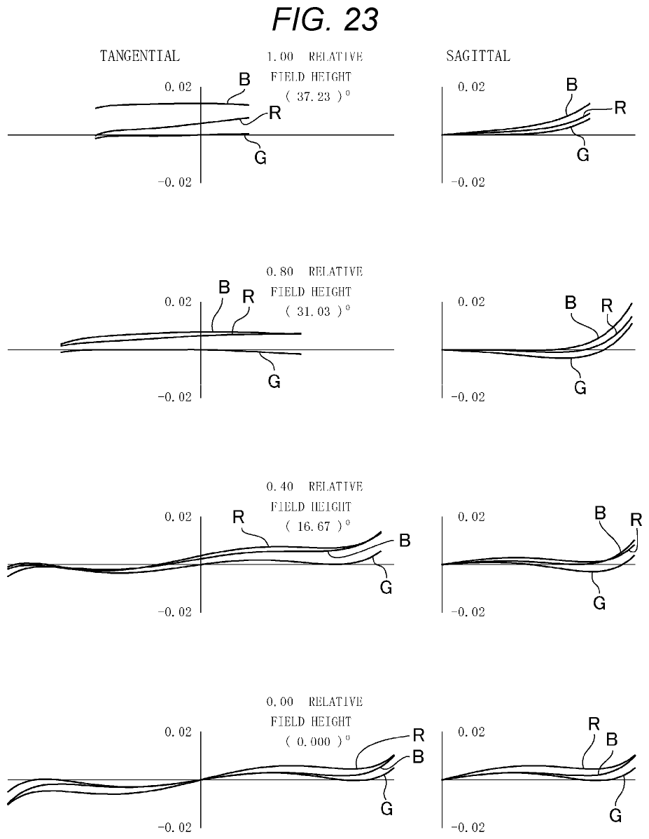

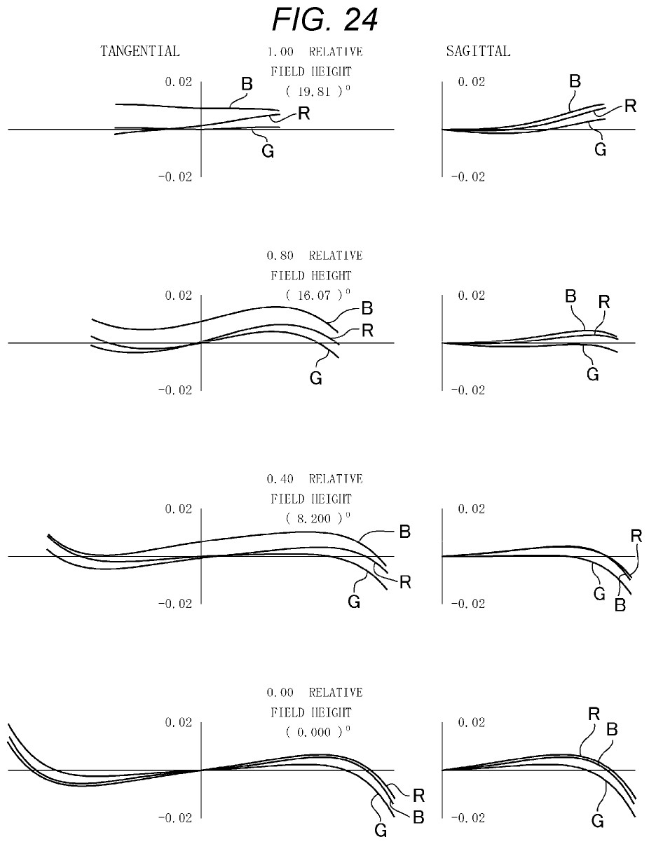

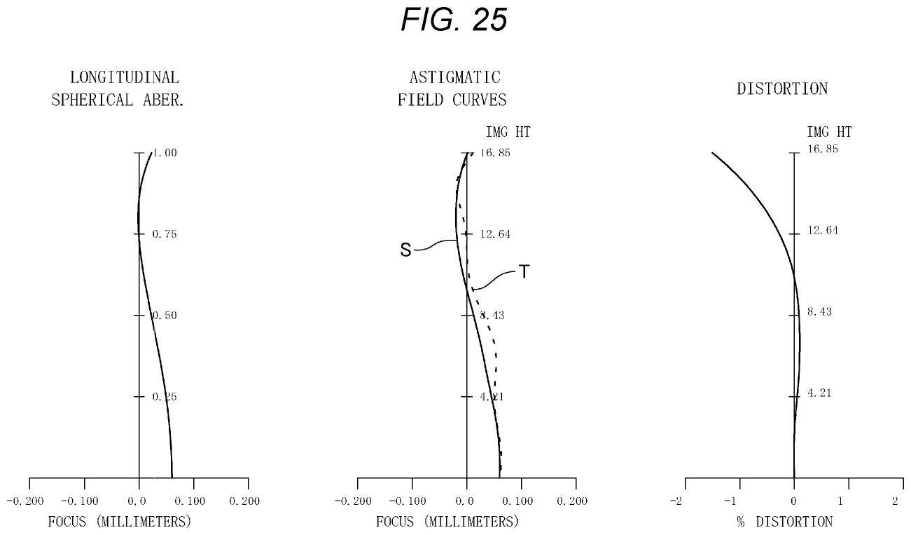

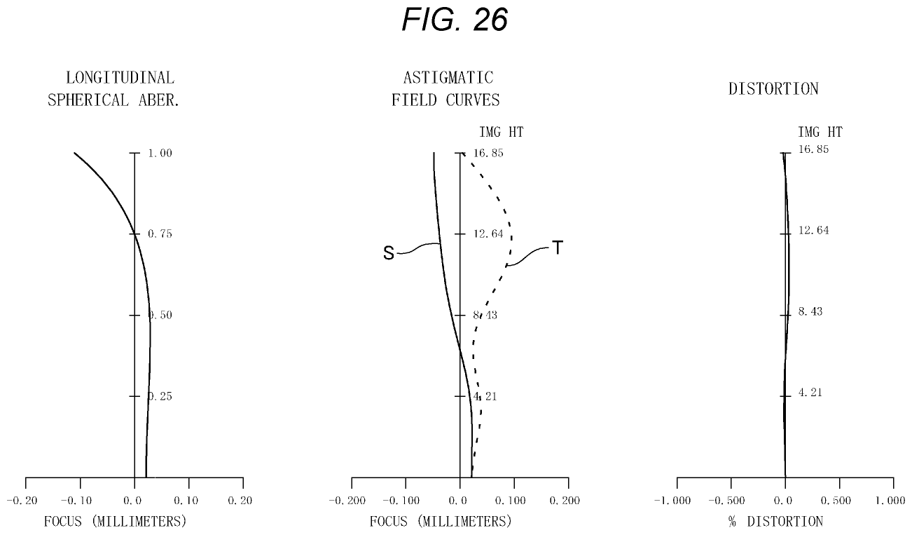

FIG. 23 is a diagram showing a coma aberration at a wide-angle end of the projection optical system 3E. FIG. 24 is a diagram showing a coma aberration at a telephoto end of the projection optical system 3E. FIG. 25 is a diagram showing a spherical aberration, an astigmatism, and a distortion at the wide-angle end of the projection optical system 3E. FIG. 26 is a diagram showing a spherical aberration, an astigmatism, and a distortion at the telephoto end of the projection optical system 3E. As shown in FIGS. 23 to 26, various aberrations are prevented in the projection optical system 3E according to the embodiment.

### Sixth Embodiment

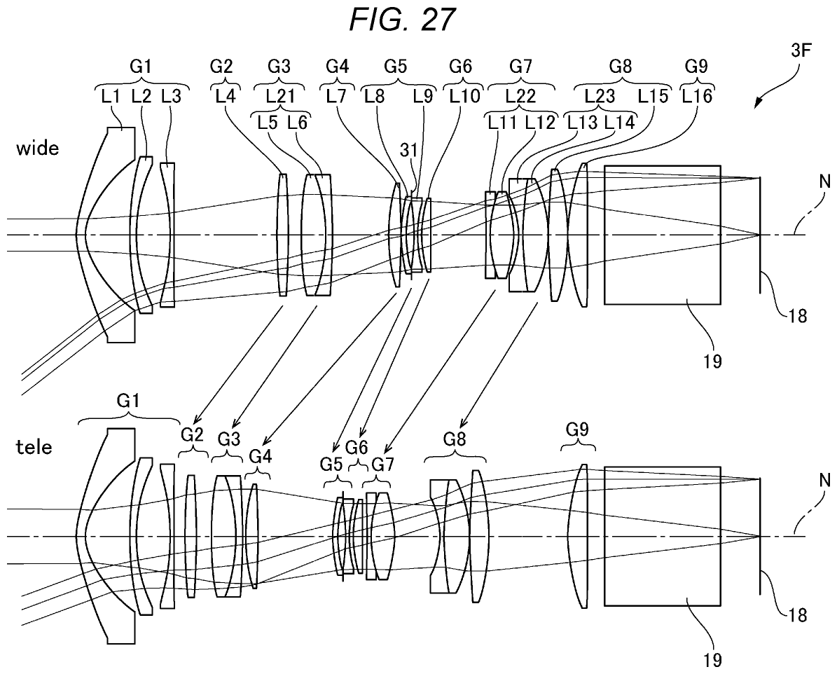

FIG. 27 is a ray diagram of a projection optical system 3F according to a sixth embodiment. As shown in FIG. 27, the projection optical system 3F includes, in an order from a magnification side to a reduction side, the first lens group G1 having negative power, the second lens group G2 having positive power, the third lens group G3 having positive power, the fourth lens group G4 having positive power, the fifth lens group G5 having negative power, the sixth lens group G6 having positive power, the seventh lens group G7 having positive power, the eighth lens group G8 having positive power, and the ninth lens group G9 having positive power. The projection optical system 3F includes the aperture stop 31 disposed between the fourth lens group G4 and the fifth lens group G5. More specifically, the aperture stop 31 is disposed inside the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes one lens L4. The lens L4 has positive power. The lens L4 has convex shapes on magnification side and reduction side surfaces thereof. The third lens group G3 includes two lenses L5 to L6. The lenses L5 to L6 are disposed in this order from the magnification side to the reduction side. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The fourth lens group G4 includes one lens L7. The lens L7 has positive power. The lens L7 has convex shapes on magnification side and reduction side surfaces thereof.

The fifth lens group G5 includes two lenses L8 to L9. The lenses L8 to L9 are disposed in this order from the magnification side to the reduction side. The lens L8 has negative power. The lens L8 is a meniscus lens. The lens L8 has a convex shape on a magnification side surface thereof and a concave shape on a reduction side surface thereof. The lens L9 has negative power. The lens L9 has concave shapes on magnification side and reduction side surfaces thereof. The aperture stop 31 is disposed between the lens L8 and the lens L9.

The sixth lens group G6 includes one lens L10. The lens L10 has positive power. The lens L10 is a meniscus lens. The lens L10 has a convex shape on a magnification side surface thereof and a concave shape on a reduction side surface thereof.

The seventh lens group G7 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form the cemented lens L22.

The eighth lens group G8 includes three lenses L13 to L15. The lenses L13 to L15 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form the cemented lenses L23. The lens L15 has positive power. The lens L15 has convex shapes on magnification side and reduction side surfaces thereof.

The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3F, a reduction side from the lens L16 of the ninth lens group G9 is telecentric.

The projection optical system 3F is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3F is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the eight lenses L1 to L8), which are disposed on the magnification side with respect to the aperture stop 31, at the wide-angle end is F1, a focal length of the fifth lens group G5 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3F is as follows.

| FNo (wide-angle end | 2.33-2.88 | |
|---|---|---|
| to telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 31.324 | mm |
| Fgs | −36.70 | mm |
| Fg1 | −32.146 | mm |
| Fg2 | 138.520 | mm |
| Fg3 | 107.262 | mm |

| Reference | Surface | | | | |
|---|---|---|---|---|---|
| numeral | number | R | D | Nd | Vd |
| S | 0 | 1.00E+18 | 2390.0000 | | |
| L01 | 1* | 20.0458 | 2.7981 | 1.53504 | 55.711 |
| | 2* | 12.2186 | 13.4460 | | |
| L02 | 3 | 87.8779 | 2.0000 | 1.48749 | 70.236 |
| | 4 | 48.0463 | 10.2888 | | |
| L03 | 5 | −71.6094 | 1.2000 | 1.51434 | 67.651 |
| | 6 | 972.1127 | Variable | | |
| | | | interval 1 | | |
| L04 | 7 | 217.3140 | 3.4567 | 1.74950 | 35.333 |
| | 8 | −199.7172 | Variable | | |
| | | | interval 2 | | |
| L05 | 9 | 99.5045 | 7.4687 | 1.72047 | 34.708 |
| L06 | 10 | −51.2689 | 2.1882 | 1.75520 | 27.580 |
| | 11 | −268.6169 | Variable | | |
| | | | interval 3 | | |
| L07 | 12 | 57.0394 | 3.7975 | 1.60381 | 60.996 |
| | 13 | −216.9517 | Variable | | |
| | | | interval 4 | | |
| L08 | 14 | 42.4128 | 1.2000 | 1.49877 | 64.061 |
| 31 | 15 | 31.5674 | 2.6526 | | |
| L09 | 16 | −72.3615 | 1.2000 | 1.56839 | 60.206 |
| | 17 | 37.2788 | Variable | | |
| | | | interval 5 | | |
| L10 | 18 | 35.3459 | 2.7079 | 1.62353 | 59.703 |
| | 19 | 188.6762 | Variable | | |
| | | | interval 6 | | |
| L11 | 20 | −221.0245 | 1.2000 | 1.75520 | 27.580 |
| L12 | 21 | 38.1236 | 7.2028 | 1.49700 | 81.546 |
| | 22 | −36.2941 | Variable | | |
| | | | interval 7 | | |
| L13 | 23 | −26.9669 | 1.2000 | 1.73019 | 28.667 |
| L14 | 24 | 86.1976 | 7.8766 | 1.49700 | 81.546 |
| | 25 | −36.6618 | 0.1042 | | |
| L15 | 26 | 202.9524 | 5.7388 | 1.80810 | 22.761 |
| | 27 | −63.5908 | Variable | | |
| | | | interval 8 | | |
| L16 | 28 | 53.4373 | 6.1731 | 1.43875 | 94.661 |
| | 29 | −626.3333 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8300 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 31.4100 | 3.4100 |
| Variable interval 2 | 3.9000 | 4.5100 |
| Variable interval 3 | 17.1100 | 1.0000 |
| Variable interval 4 | 0.1000 | 22.8700 |
| Variable interval 5 | 1.0650 | 0.7610 |
| Variable interval 6 | 16.9600 | 1.6100 |
| Variable interval 7 | 1.4500 | 13.9900 |
| Variable interval 8 | 0.1000 | 24.5700 |

Each aspherical coefficient is as follows.

| Surface number | 1 | 2 |
|---|---|---|
| R | 20.0458 | 12.2186 |
| Conic constant (R) | −3.4621 | −12.2186 |
| 4th-order | −3.973372E−05 | −9.739418E−05 |
| coefficient | | |
| 6th-order | 1.7649110E−07 | 3.777112E−07 |
| coefficient | | |
| 8th-order | −4.895007E−10 | −1.3790450E−09 |
| coefficient | | |
| 10th-order | 9.480503E−13 | 4.489673E−12 |
| coefficient | | |
| 12th-order | −1.2975442E−15 | −1.306716E−14 |
| coefficient | | |
| 14th-order | 1.242370E−18 | 3.007133E−17 |
| coefficient | | |
| 16th-order | −8.07778847E−22 | −4.747110E−20 |
| coefficient | | |
| 18th-order | 3.282877E−25 | 4.393617E−23 |
| coefficient | | |
| 20th-order | −6.4142404E−29 | −1.773577E−26 |
| coefficient | | |

Here, the projection optical system 3F according to the embodiment satisfies the conditional expressions (1) to (8) similarly to the projection optical system 3A according to the first embodiment.

In the embodiment, variables are as below.

| | | |
|---|---|---|
| F1 | 31.324 | mm |
| Fw | 23.520 | mm |

Therefore, F1/Fw=1.332, which satisfies the conditional expression (1).

In the embodiment, variables are as below.

| | | |
|---|---|---|
| Fgs | −36.70 | mm |
| Fw | 23.520 | mm |

Therefore, Fgs/Fw=−1.56, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −32.146 | mm |

Therefore, Fg1/Fw=−1.37, which satisfies the conditional expression (4).

In the embodiment, variables are as below.

| | | |
|---|---|---|
| Fw | 23.520 | mm |
| Fg2 | 138.520 | mm |

Therefore, Fg2/Fw=5.889, which satisfies the conditional expression (5).

In the embodiment, variables are as below.

| | | |
|---|---|---|
| Fg2 | 138.520 | mm |
| Fg3 | 107.262 | mm |

Therefore, Fg2/Fg3=1.291, which satisfies the conditional expression (6).

In the embodiment, variables are as below.

| | |
|---|---|
| Nd1 | 1.720 |
| Nd2 | 1.755 |
| Vd1 | 34.708 |
| Vd2 | 27.580 |

Therefore, |(Nd1×Vd1)−(Nd2× Vd2)|=11.306, which satisfies the conditional expression (7).

In the embodiment, Nd2=1.755, which satisfies the conditional expression (8).

### Effects

According to the embodiment, since the projection optical system 3F has a configuration similar to that of the projection optical system 3A according to the first embodiment, effects similar to those of the projection optical system 3A according to the first embodiment can be obtained.

Since the projection optical system 3F according to the embodiment satisfies the conditional expressions (1) to (8), effects similar to those of the projection optical system 3A according to the first embodiment can be obtained.

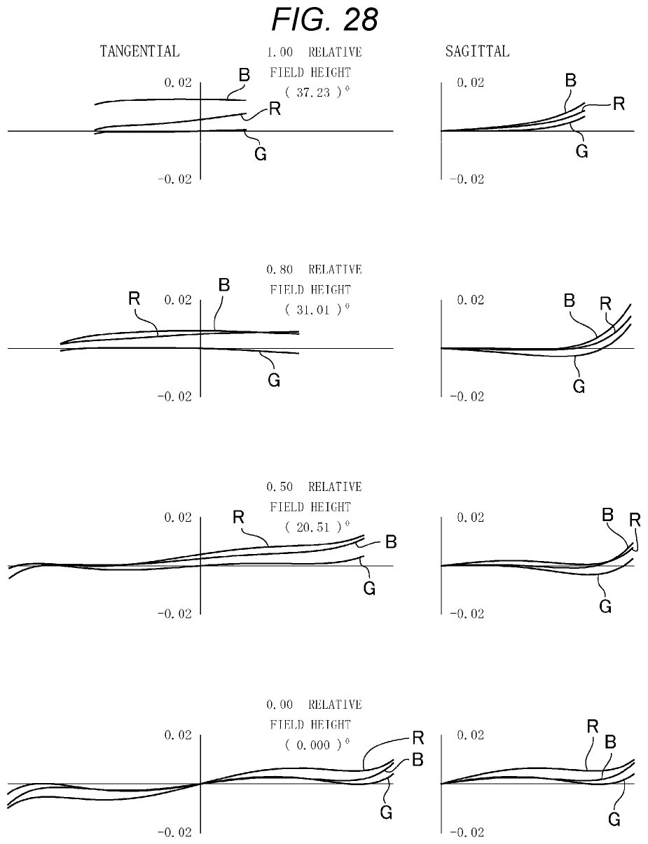

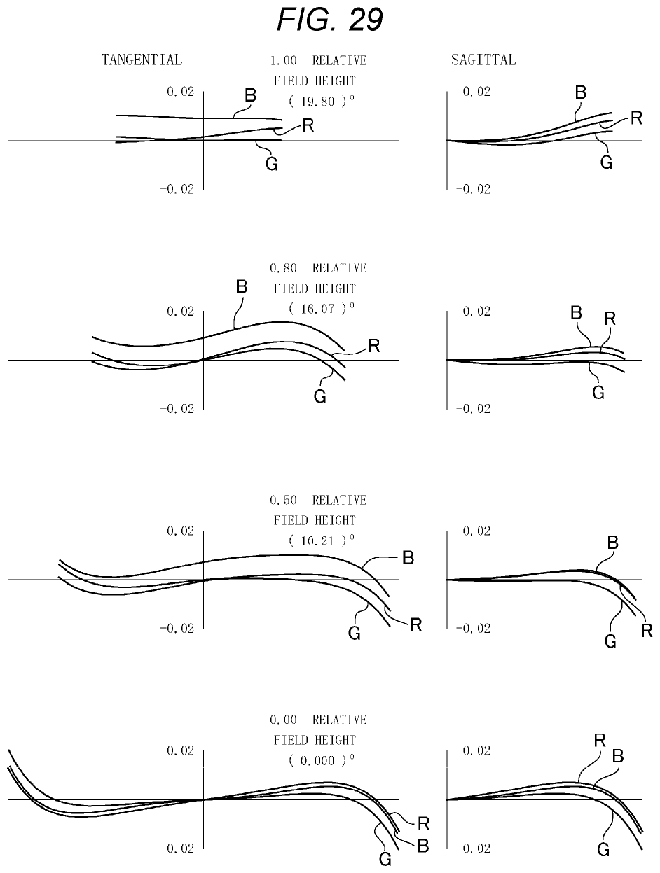

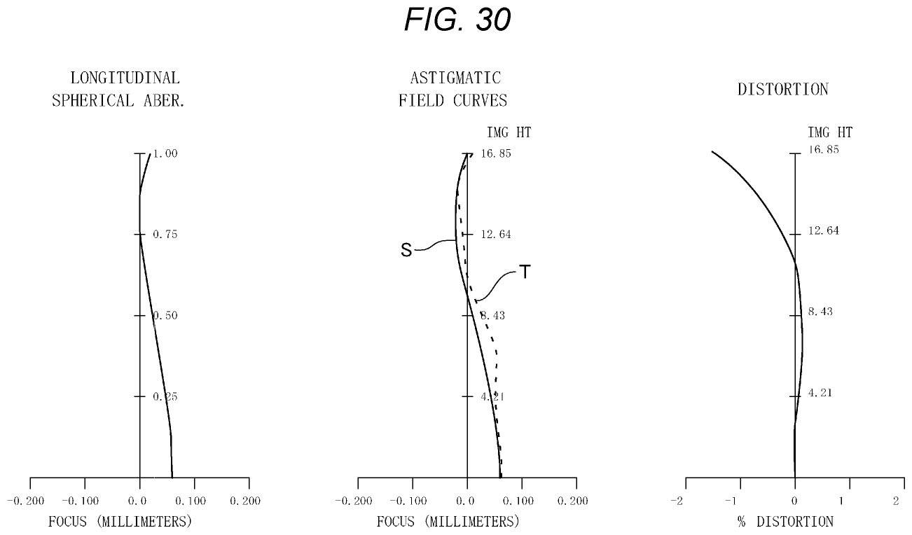

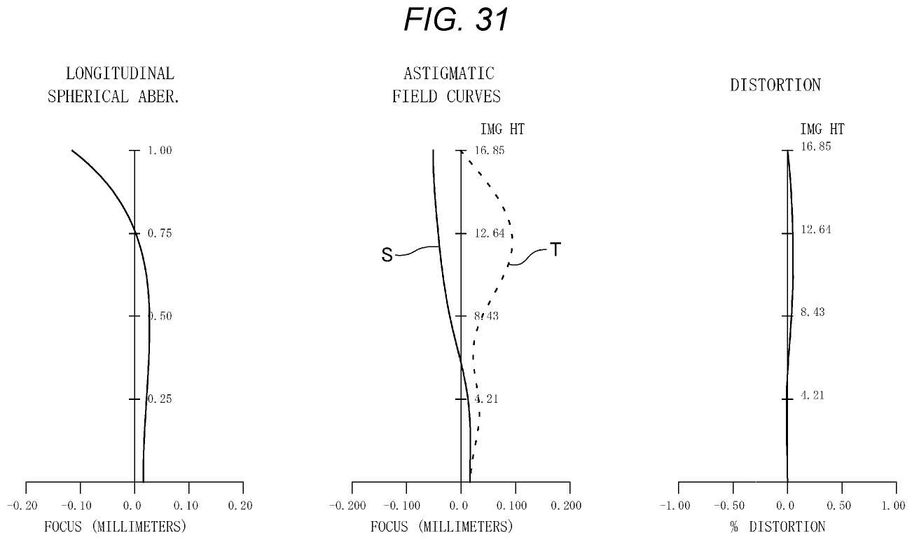

FIG. 28 is a diagram showing a coma aberration at a wide-angle end of the projection optical system 3F. FIG. 29 is a diagram showing a coma aberration at a telephoto end of the projection optical system 3F. FIG. 30 is a diagram showing a spherical aberration, an astigmatism, and a distortion at the wide-angle end of the projection optical system 3F. FIG. 31 is a diagram showing a spherical aberration, an astigmatism, and a distortion at the telephoto end of the projection optical system 3F. As shown in FIGS. 28 to 31, various aberrations are prevented in the projection optical system 3F according to the embodiment.

### Seventh Embodiment

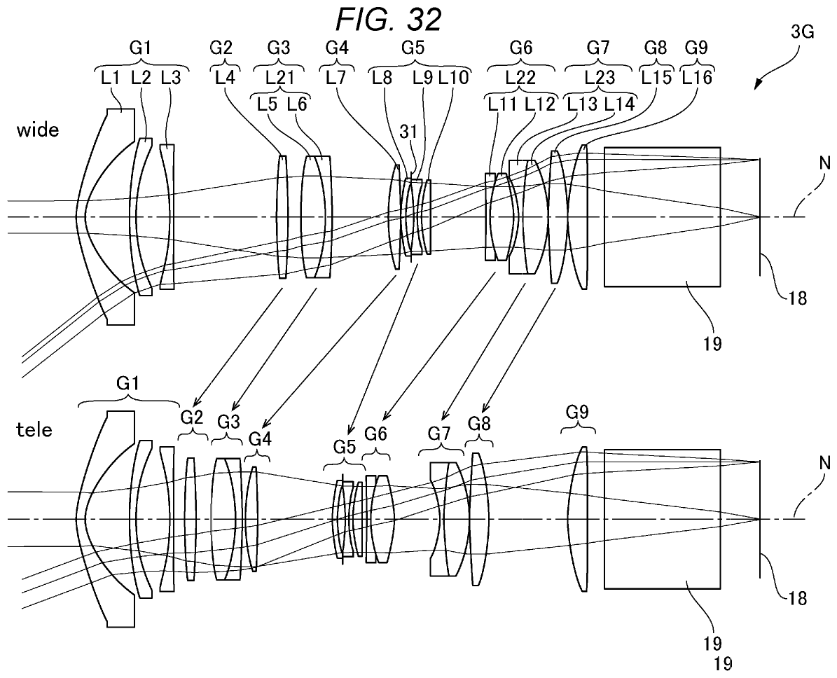

FIG. 32 is a ray diagram of a projection optical system 3G according to a seventh embodiment. As shown in FIG. 32, the projection optical system 3G includes, in an order from a magnification side to a reduction side, the first lens group G1 having negative power, the second lens group G2 having positive power, the third lens group G3 having positive power, the fourth lens group G4 having positive power, the fifth lens group G5 having negative power, the sixth lens group G6 having positive power, the seventh lens group G7 having negative power, the eighth lens group G8 having positive power, and the ninth lens group G9 having positive power. The projection optical system 3G includes the aperture stop 31 disposed between the fourth lens group G4 and the fifth lens group G5. More specifically, the aperture stop 31 is disposed inside the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes one lens L4. The lens L4 has positive power. The lens L4 has convex shapes on magnification side and reduction side surfaces thereof. The third lens group G3 includes two lenses L5 to L6. The lenses L5 to L6 are disposed in this order from the magnification side to the reduction side. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21. The fourth lens group G4 includes one lens L7. The lens L7 has positive power. The lens L7 has convex shapes on magnification side and reduction side surfaces thereof.

The fifth lens group G5 includes three lenses L8 to L10. The lenses L8 to L10 are disposed in this order from the magnification side to the reduction side. The lens L8 has negative power. The lens L8 is a meniscus lens. The lens L8 has a convex shape on a magnification side surface thereof and a concave shape on a reduction side surface thereof. The lens L9 has negative power. The lens L9 has concave shapes on magnification side and reduction side surfaces thereof. The lens L10 has positive power. The lens L10 is a meniscus lens. The lens L10 has a convex shape on a magnification side surface thereof and a concave shape on a reduction side surface thereof. The aperture stop 31 is disposed between the lens L8 and the lens L9.

The sixth lens group G6 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form the cemented lens L22.

The seventh lens group G7 includes two lenses L13 to L14. The lenses L13 to L14 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form the cemented lenses L23.

The eighth lens group G8 includes one lens L15. The lens L15 has positive power. The lens L15 has convex shapes on magnification side and reduction side surfaces thereof. The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3G, a reduction side from the lens L16 of the ninth lens group G9 is telecentric.

The projection optical system 3G is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3G is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the eight lenses L1 to L8), which are disposed on the magnification side with respect to the aperture stop 31, at the wide-angle end is F1, a focal length of the fifth lens group G5 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3G is as follows.

| FNo (wide-angle end | 2.35-2.85 | |
|---|---|---|
| to telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 33.317 | mm |
| Fgs | −82.61 | mm |
| Fg1 | −32.116 | mm |
| Fg2 | 143.864 | mm |
| Fg3 | 100.117 | mm |

| Reference | Surface | | | | |
|---|---|---|---|---|---|
| numeral | number | R | D | Nd | Vd |
| S | 0 | 1.00E+18 | 2390.0000 | | |
| L01 | 1* | 20.1301 | 2.8463 | 1.53504 | 55.711 |
| | 2* | 12.2359 | 13.3811 | | |
| L02 | 3 | 88.8167 | 2.0000 | 1.48749 | 70.236 |
| | 4 | 48.5410 | 10.3274 | | |
| L03 | 5 | −79.2914 | 1.2274 | 1.51542 | 67.551 |
| | 6 | 413.2381 | Variable | | |
| | | | interval 1 | | |
| L04 | 7 | 209.1647 | 3.5012 | 1.74587 | 39.944 |
| | 8 | −221.1640 | Variable | | |
| | | | interval 2 | | |
| L05 | 9 | 91.1381 | 7.4613 | 1.72047 | 34.708 |
| L06 | 10 | −58.4609 | 1.6156 | 1.75393 | 28.228 |
| | 11 | −279.2460 | Variable | | |
| | | | interval 3 | | |
| L07 | 12 | 56.8285 | 3.8324 | 1.60418 | 60.915 |
| | 13 | −245.0030 | Variable | | |
| | | | interval 4 | | |
| L08 | 14 | 55.5021 | 1.2000 | 1.49700 | 81.546 |
| 31 | 15 | 35.4724 | 2.5386 | | |
| L09 | 16 | −65.9979 | 1.2000 | 1.56801 | 54.591 |
| | 17 | 42.8589 | 1.4187 | | |
| L10 | 18 | 40.4976 | 2.6818 | 1.62392 | 59.628 |
| | 19 | 542.9665 | Variable | | |
| | | | interval 5 | | |
| L11 | 20 | −246.1490 | 1.2000 | 1.75520 | 27.580 |
| L12 | 21 | 37.6621 | 7.1391 | 1.49700 | 81.546 |
| | 22 | −37.1400 | Variable | | |
| | | | interval 6 | | |
| L13 | 23 | −27.1235 | 1.2000 | 1.72990 | 28.681 |
| L14 | 24 | 87.9931 | 7.8816 | 1.49700 | 81.546 |
| | 25 | −36.7091 | Variable | | |
| | | | interval 7 | | |
| L15 | 26 | 198.5995 | 5.6821 | 1.80810 | 22.761 |
| | 27 | −63.8884 | Variable | | |
| | | | interval 8 | | |
| L16 | 28 | 53.9192 | 5.8708 | 1.43875 | 94.661 |
| | 29 | −910.9640 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8300 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 31.6900 | 3.4300 |
| Variable interval 2 | 4.2000 | 3.9400 |
| Variable interval 3 | 17.2000 | 1.0000 |
| Variable interval 4 | 0.1000 | 22.8600 |
| Variable interval 5 | 16.9000 | 1.6900 |
| Variable interval 6 | 1.5000 | 14.3500 |
| Variable interval 7 | 0.1100 | 0.4200 |
| Variable interval 8 | 0.1000 | 24.5600 |

Each aspherical coefficient is as follows.

| Surface number | 1 | 2 |
|---|---|---|
| R | 20.1301 | 12.2359 |
| Conic constant (K) | −3.4871 | −0.8445 |
| 4th-order | −4.013925E−05 | −9.773576E−05 |
| coefficient | | |
| 6th-order | 1.764436E−07 | 3.793081E−07 |
| coefficient | | |
| 8th-order | −4.891010E−10 | −1.383170E−09 |
| coefficient | | |
| 10th-order | 9.481087E−13 | 4.491488E−12 |
| coefficient | | |
| 12th-order | −1.297609E−15 | −1.304884E−14 |
| coefficient | | |
| 14th-order | 1.242138E−18 | 3.005649E−17 |
| coefficient | | |
| 16th-order | −8.078438E−22 | −4.7445170E−20 |
| coefficient | | |
| 18th-order | 3.285837E−25 | 4.380567E−23 |
| coefficient | | |
| 20th-order | −6.419826E−29 | −1.758697E−26 |
| coefficient | | |

Here, the projection optical system 3G according to the embodiment satisfies the conditional expressions (1) to (8) similarly to the projection optical system 3A according to the first embodiment.

In the embodiment, variables are as below.

| | | |
|---|---|---|
| F1 | 33.317 | mm |
| Fw | 23.520 | mm |

Therefore, F1/Fw=1.417, which satisfies the conditional expression (1).

In the embodiment, variables are as below.

| | | |
|---|---|---|
| Fgs | −82.61 | mm |
| Fw | 23.520 | mm |

Therefore, Fgs/Fw=−3.51, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −32.116 | mm |

Therefore, Fg1/Fw=−1.37, which satisfies the conditional expression (4).

In the embodiment, variables are as below.

| | | |
|---|---|---|
| Fw | 23.520 | mm |
| Fg2 | 143.864 | mm |

Therefore, Fg2/Fw=6.117, which satisfies the conditional expression (5).

In the embodiment, variables are as below.

| | | |
|---|---|---|
| Fg2 | 143.864 | mm |
| Fg3 | 100.117 | mm |

Therefore, Fg2/Fg3=1.437, which satisfies the conditional expression (6).

In the embodiment, variables are as below.

| | |
|---|---|
| Nd1 | 1.720 |
| Nd2 | 1.754 |
| Vd1 | 34.708 |
| Vd2 | 28.228 |

Therefore, |(Nd1×Vd1)−(Nd2×Vd2)|=10.205, which satisfies the conditional expression (7).

In the embodiment, Nd2=1.754, which satisfies the conditional expression (8).

### Effects

According to the embodiment, since the projection optical system 3G has a configuration similar to that of the projection optical system 3A according to the first embodiment, effects similar to those of the projection optical system 3A according to the first embodiment can be obtained.

Since the projection optical system 3G according to the embodiment satisfies the conditional expressions (1) to (8), effects similar to those of the projection optical system 3A according to the first embodiment can be obtained.

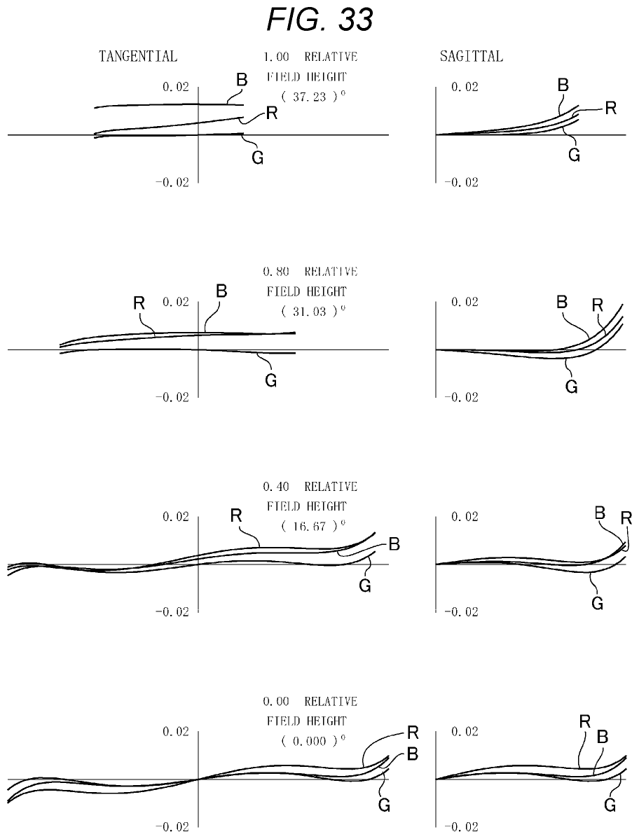

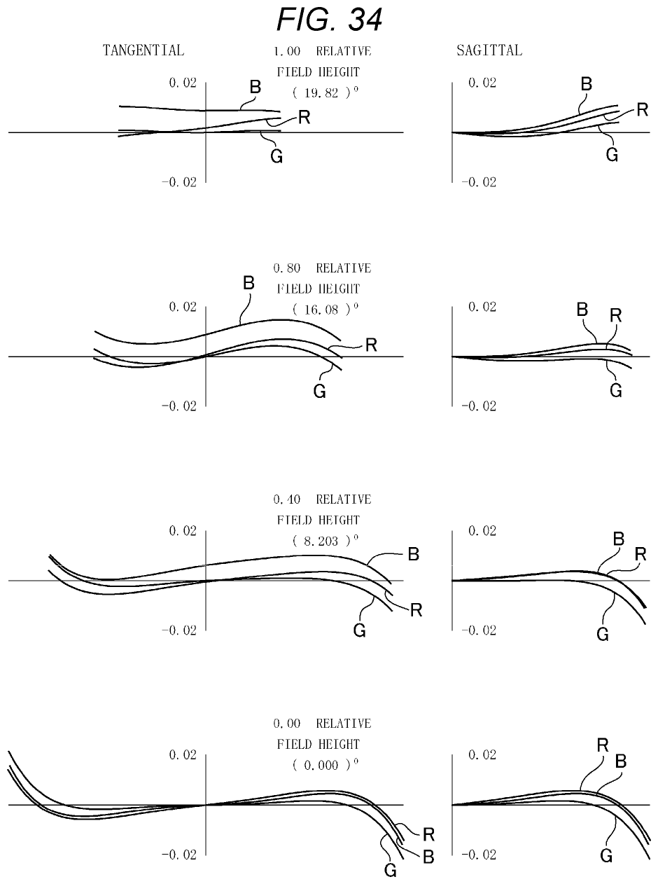

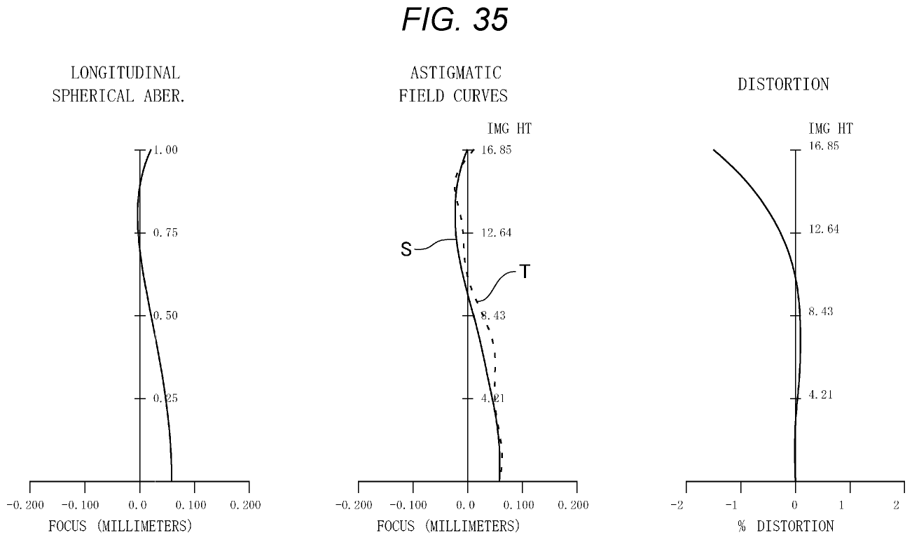

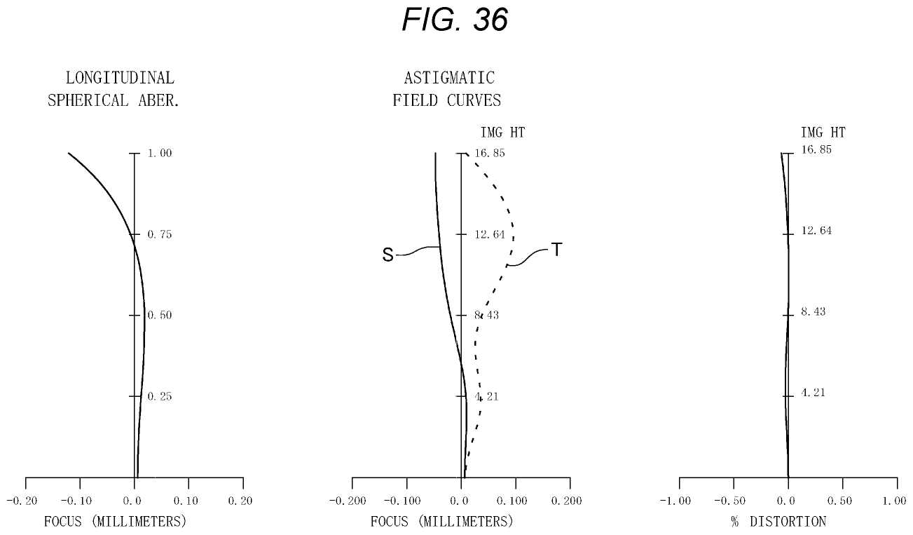

FIG. 33 is a diagram showing a coma aberration at a wide-angle end of the projection optical system 3G. FIG. 34 is a diagram showing a coma aberration at a telephoto end of the projection optical system 3G. FIG. 35 is a diagram showing a spherical aberration, an astigmatism, and a distortion at the wide-angle end of the projection optical system 3G. FIG. 36 is a diagram showing a spherical aberration, an astigmatism, and a distortion at the telephoto end of the projection optical system 3G. As shown in FIGS. 33 to 36, various aberrations are prevented in the projection optical system 3G according to the embodiment.

### Eighth Embodiment

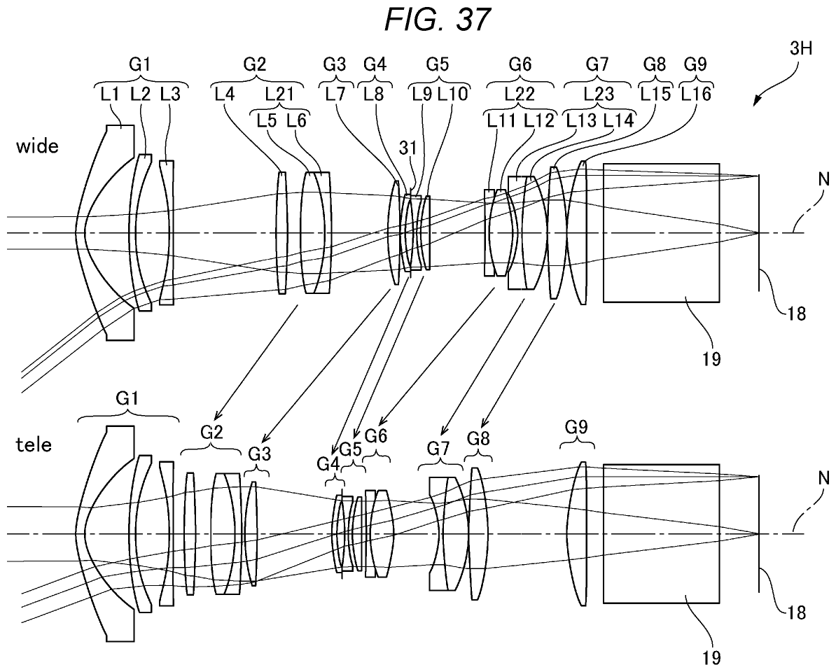

FIG. 37 is a ray diagram of a projection optical system 3H according to an eighth embodiment. As shown in FIG. 37, the projection optical system 3H includes, in an order from a magnification side to a reduction side, the first lens group G1 having negative power, the second lens group G2 having positive power, the third lens group G3 having positive power, the fourth lens group G4 having negative power, the fifth lens group G5 having negative power, the sixth lens group G6 having positive power, the seventh lens group G7 having negative power, the eighth lens group G8 having positive power, and the ninth lens group G9 having positive power. The projection optical system 3H includes the aperture stop 31 disposed between the fourth lens group G4 and the fifth lens group G5.

The first lens group G1 includes three lenses L1 to L3. The lenses L1 to L3 are disposed in this order from the magnification side toward the reduction side. The lens L1 is made of resin. The lens L1 has negative power. The lens L2 has negative power. The lens L2 is a meniscus lens. The lens L2 has a convex shape on a magnification side surface thereof and a concave shape on a reduction side surface thereof. The lens L3 has negative power. The lens L3 has concave shapes on magnification side and reduction side surfaces thereof.

The second lens group G2 includes three lenses L4 to L6. The lenses L4 to L6 are disposed in this order from the magnification side to the reduction side. The lens L4 has positive power. The lens L4 has convex shapes on magnification side and reduction side surfaces thereof. The lens L5 (positive lens, first lens) has positive power. The lens L5 has convex shapes on magnification side and reduction side surfaces thereof. The lens L6 (negative lens, second lens) has negative power. The lens L6 is a meniscus lens. The lens L6 has a concave shape on a magnification side surface thereof and a convex shape on a reduction side surface thereof. The lens L5 and the lens L6 are cemented to form a cemented lens L21.

The third lens group G3 includes one lens L7. The lens L7 has positive power. The lens L7 has convex shapes on magnification side and reduction side surfaces thereof. The fourth lens group G4 includes one lens L8. The lens L8 has negative power. The lens L8 is a meniscus lens. The lens L8 has a convex shape on a magnification side surface thereof and a concave shape on a reduction side surface thereof.

The fifth lens group G5 includes two lenses L9 to L10. The lenses L9 to L10 are disposed in this order from the magnification side to the reduction side. The lens L9 has negative power. The lens L9 has concave shapes on magnification side and reduction side surfaces thereof. The lens L10 has positive power. The lens L10 is a meniscus lens. The lens L10 has a convex shape on a magnification side surface thereof and a concave shape on a reduction side surface thereof.

The sixth lens group G6 includes two lenses L11 to L12. The lenses L11 to L12 are disposed in this order from the magnification side to the reduction side. The lens L11 has negative power. The lens L11 has concave shapes on magnification side and reduction side surfaces thereof. The lens L12 has positive power. The lens L12 has convex shapes on magnification side and reduction side surfaces thereof. The lens L11 and the lens L12 are cemented to form the cemented lens L22.

The seventh lens group G7 includes two lenses L13 to L14. The lenses L13 to L14 are disposed in this order from the magnification side to the reduction side. The lens L13 has negative power. The lens L13 has concave shapes on magnification side and reduction side surfaces thereof. The lens L14 has positive power. The lens L14 has convex shapes on magnification side and reduction side surfaces thereof. The lens L13 and the lens L14 are cemented to form the cemented lenses L23.

The eighth lens group G8 includes one lens L15. The lens L15 has positive power. The lens L15 has convex shapes on magnification side and reduction side surfaces thereof. The ninth lens group G9 includes one lens L16. The lens L16 has positive power. The lens L16 has convex shapes on magnification side and reduction side surfaces thereof.

Here, the lens L1 is an aspherical lens having aspherical shapes on magnification side and reduction side surfaces thereof. The lenses L2 to L16 are spherical lenses having spherical shapes on magnification side and reduction side surfaces thereof.

In the projection optical system 3H, a reduction side of from the lens L16 of the ninth lens group G9 is telecentric.

The projection optical system 3H is a zoom lens and changes an angle of view between a wide-angle end and a telephoto end. In the projection optical system 3, during zooming, the first lens group G1 and the ninth lens group G9 are fixed, and the second lens group G2, the third lens group G3, the fourth lens group G4, the fifth lens group G5, the sixth lens group G6, the seventh lens group G7, and the eighth lens group G8 move along the optical axis N. The second lens group G2, the third lens group G3, the fourth lens group G4, the fifth lens group G5, the sixth lens group G6, the seventh lens group G7, and the eighth lens group G8 each move from the reduction side to the magnification side along the optical axis N when zooming from the wide-angle end to the telephoto end. In the embodiment, a zoom ratio is about 2.08.

When an F number of the projection optical system 3H is FNo, a focal length of the entire system at the wide-angle end is Fw, a focal length of the entire system at the telephoto end is Ft, a zoom ratio is Z, a back focus is BF, a total lens length (a distance from an object side surface of the lens L1 to a reduction side surface of the lens L16) is LL, a maximum image height of the liquid crystal panel 18 is IH, a composite focal length of all the lenses (the eight lenses L1 to L8), which are disposed on the magnification side with respect to the aperture stop 31, at the wide-angle end is F1, a focal length of the fourth lens group G4 having negative power and disposed at a position closest to the aperture stop 31 is Fgs, a focal length of the first lens group G1 is Fg1, a focal length of the second lens group G2 is Fg2, and a focal length of the third lens group G3 is Fg3, data on the projection optical system 3H is as follows.

| FNo (wide-angle end | 2.40-2.87 | |
|---|---|---|
| to telephoto end) | | |
| Fw | 23.520 | mm |
| Ft | 48.960 | mm |
| Z | 2.082 | |
| BF | 52.487 | mm |
| LL | 156.000 | mm |
| IH | 16.850 | mm |
| F1 | 33.787 | mm |
| Fgs | −195.53 | mm |
| Fg1 | −32.051 | mm |
| Fg2 | 61.827 | mm |
| Fg3 | 74.856 | mm |

| Reference | Surface | | | | |
|---|---|---|---|---|---|
| numeral | number | R | D | Nd | Vd |
| S | 0 | 1.00E+18 | 2390.0000 | | |
| L01 | 1* | 20.1289 | 2.7927 | 1.53504 | 55.711 |
| | 2* | 12.2103 | 13.3732 | | |
| L02 | 3 | 85.4921 | 2.0000 | 1.48749 | 70.236 |
| | 4 | 47.9675 | 10.3044 | | |
| L03 | 5 | −78.3723 | 1.2109 | 1.51560 | 67.534 |
| | 6 | 436.2567 | Variable | | |
| | | | interval 1 | | |
| L04 | 7 | 210.5310 | 3.4773 | 1.74950 | 35.333 |
| | 8 | −229.4780 | Variable | | |
| | | | interval 2 | | |
| L05 | 9 | 91.7219 | 6.3047 | 1.72047 | 34.708 |
| L06 | 10 | −59.4167 | 1.5741 | 1.75520 | 27.512 |
| | 11 | −303.9680 | Variable | | |
| | | | interval 3 | | |
| L07 | 12 | 55.8241 | 3.7912 | 1.60360 | 60.490 |
| | 13 | −235.2930 | Variable | | |
| | | | interval 4 | | |
| L08 | 14 | 60.3098 | 1.2000 | 1.49700 | 81.546 |
| 31 | 15 | 37.0047 | 2.4211 | | |
| L09 | 16 | −69.0355 | 1.2000 | 1.56529 | 47.787 |
| | 17 | 38.7743 | 1.8302 | | |
| L10 | 18 | 38.3477 | 2.9027 | 1.62794 | 48.029 |
| | 19 | 2355.7420 | Variable | | |
| | | | interval 5 | | |
| L11 | 20 | −274.2950 | 1.2000 | 1.75519 | 27.580 |
| L12 | 21 | 36.0508 | 7.2041 | 1.49700 | 815459.000 |
| | 22 | −38.8026 | Variable | | |
| | | | interval 6 | | |
| L13 | 23 | −27.2281 | 1.2071 | 1.73096 | 28.631 |
| L14 | 24 | 87.1251 | 8.0028 | 1.49700 | 81.546 |
| | 25 | −36.8220 | Variable | | |
| | | | interval 7 | | |
| L15 | 26 | 199.0360 | 6.0787 | 1.80810 | 22.761 |
| | 27 | −63.8429 | Variable | | |
| | | | interval 8 | | |
| L16 | 28 | 55.7768 | 5.9693 | 1.43875 | 94.661 |
| | 29 | −806.5830 | 5.1000 | | |
| 19 | 30 | 1.00E+18 | 35.5400 | 1.51680 | 64.198 |
| | 31 | 1.00E+18 | 0.0000 | | |
| 18 | 32 | 1.00E+18 | 11.8700 | | |

The variable interval 1, the variable interval 2, the variable interval 3, the variable interval 4, the variable interval 5, the variable interval 6, the variable interval 7, and the variable interval 8 during zooming are shown below.

| | Wide-angle end | Telephoto end |
|---|---|---|
| Variable interval 1 | 31.7900 | 3.4400 |
| Variable interval 2 | 17.3200 | 1.0000 |
| Variable interval 3 | 0.1000 | 22.7400 |
| Variable interval 4 | 2.4200 | 3.1600 |
| Variable interval 5 | 16.9500 | 1.2400 |
| Variable interval 6 | 1.6100 | 14.5200 |
| Variable interval 7 | 0.1000 | 0.5500 |
| Variable interval 8 | 0.1000 | 24.6000 |

Each aspherical coefficient is as follows.

| Surface number | 1 | 2 |
|---|---|---|
| R | 20.1289 | 12.2103 |
| Conic constant (K) | −3.5695 | −0.8438 |
| 4th-order coefficient | −3.950127E−05 | −9.779225E−05 |
| 6th-order coefficient | 1.756658E−07 | 3.811875E−07 |
| 8th-order coefficient | −4.887410E−10 | −1.386252E−09 |
| 10th-order coefficient | 9.483987E−13 | 4.489820E−12 |
| 12th-order coefficient | −1.297709E−15 | −1.304176E−14 |
| 14th-order coefficient | 1.241896E−18 | 3.007133E−17 |
| 16th-order coefficient | −8.078803E−22 | −4.748685E−20 |
| 18th-order coefficient | 3.287584E−25 | 4.381519E−23 |
| 20th-order coefficient | −6.424307E−29 | −1.758420E−26 |

Here, the projection optical system 3H according to the embodiment satisfies the conditional expressions (1) to (8) similarly to the projection optical system 3A according to the first embodiment.

In the embodiment, variables are as below.

| | | |
|---|---|---|
| F1 | 33.787 | mm |
| Fw | 23.520 | mm |

Therefore, F1/Fw=1.437, which satisfies the conditional expression (1).

In the embodiment, variables are as below.

| | | |
|---|---|---|
| Fgs | −195.53 | mm |
| Fw | 23.520 | mm |

Therefore, Fgs/Fw=−8.31, which satisfies the conditional expression (2).

In the embodiment, variables are as below.

| | | |
|---|---|---|
| Fw | 23.520 | mm |
| Ft | 48.960 | mm |
| LL | 156.000 | mm |
| IH | 16.850 | mm |

Therefore, (LL/IH)/(Ft/Fw)=4.448, which satisfies the conditional expression (3).

In the embodiment, variables are as below.

| | | |
|---|---|---|
| Fw | 23.520 | mm |
| Fg1 | −32.051 | mm |

Therefore, Fg1/Fw=−1.36, which satisfies the conditional expression (4).

In the embodiment, variables are as below.

| | | |
|---|---|---|
| Fw | 23.520 | mm |
| Fg2 | 61.827 | mm |

Therefore, Fg2/Fw=2.629, which satisfies the conditional expression (5).

In the embodiment, variables are as below.

| | | |
|---|---|---|
| Fg2 | 61.827 | mm |
| Fg3 | 74.856 | mm |

Therefore, Fg2/Fg3=0.826, which satisfies the conditional expression (6).

In the embodiment, variables are as below.

| | |
|---|---|
| Nd1 | 1.720 |
| Nd2 | 1.755 |
| Vd1 | 34.708 |
| Vd2 | 27.512 |

Therefore, |(Nd1×Vd1)−(Nd2×Vd2)|=11.425, which satisfies the conditional expression (7).

In the embodiment, Nd2=1.755, which satisfies the conditional expression (8).

### Effects

According to the embodiment, since the projection optical system 3H has a configuration similar to that of the projection optical system 3A according to the first embodiment, effects similar to those of the projection optical system 3A according to the first embodiment can be obtained.

Since the projection optical system 3H according to the embodiment satisfies the conditional expressions (1) to (8), effects similar to those of the projection optical system 3A according to the first embodiment can be obtained.

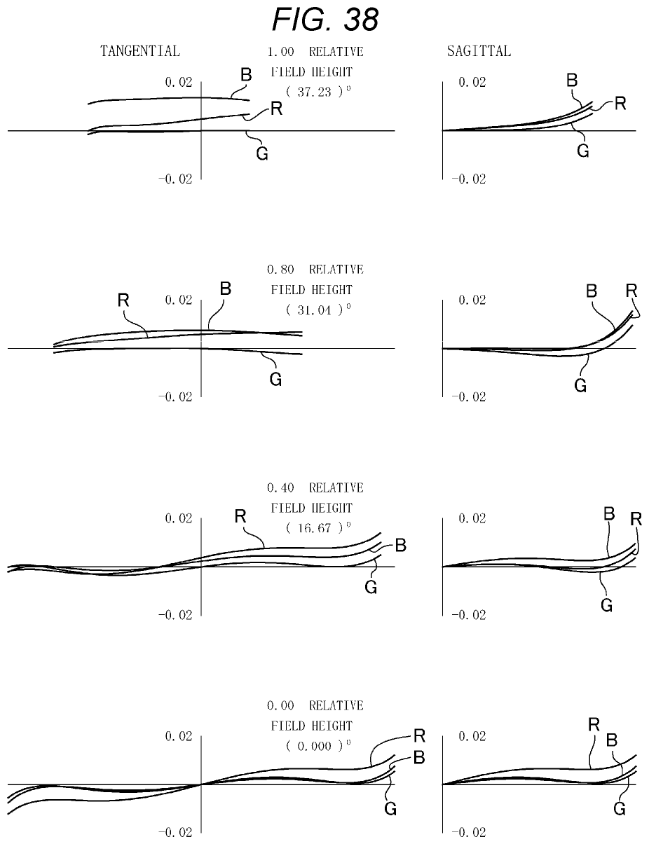

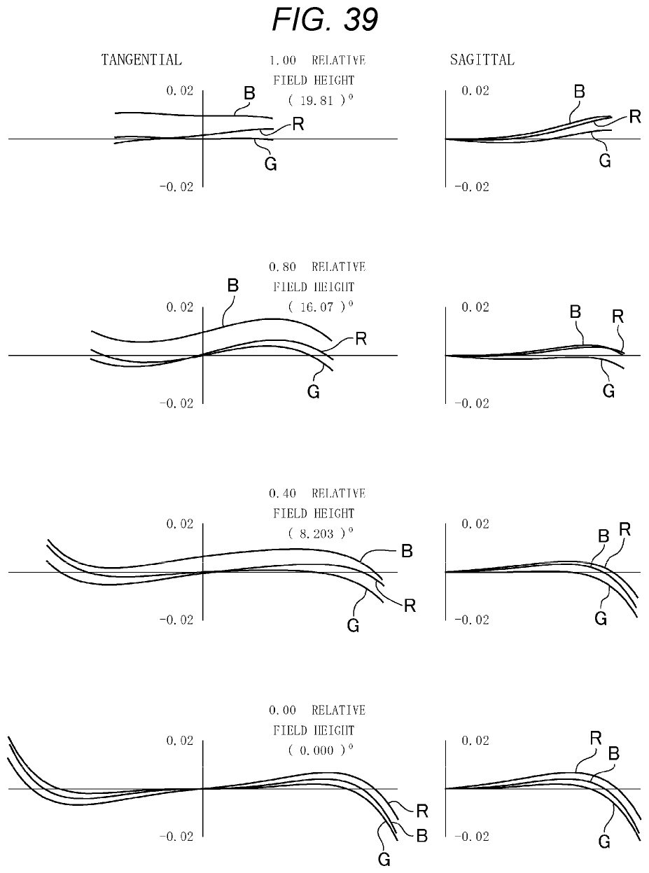

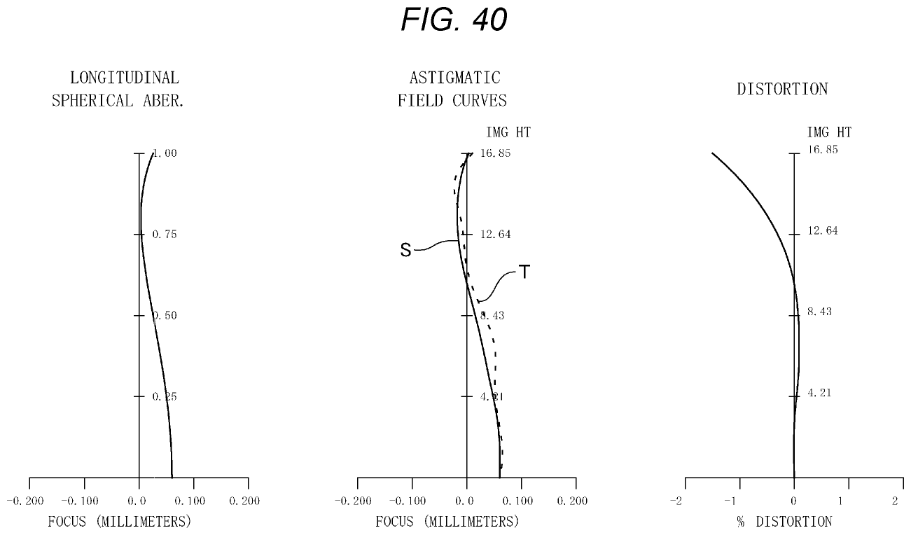

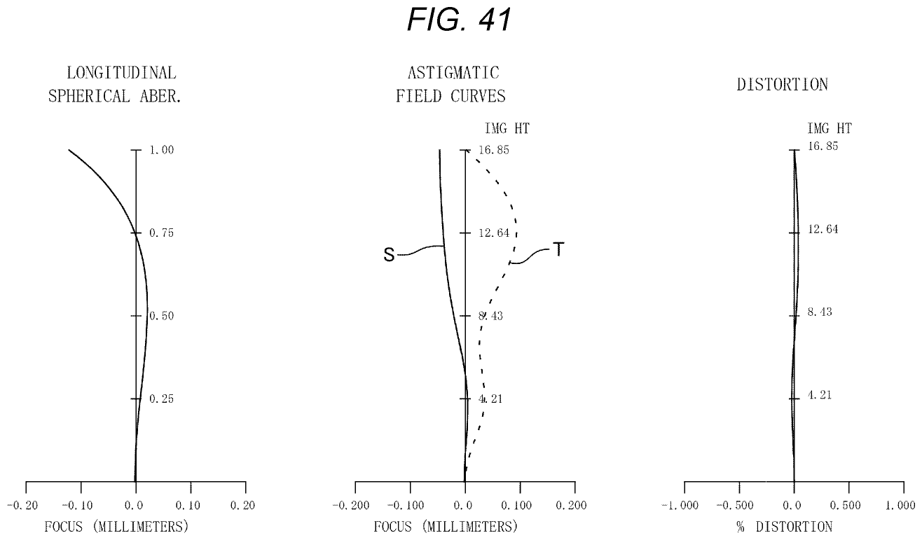

FIG. 38 is a diagram showing a coma aberration at a wide-angle end of the projection optical system 3H. FIG. 39 is a diagram showing a coma aberration at a telephoto end of the projection optical system 3H. FIG. 40 is a diagram showing a spherical aberration, an astigmatism, and a distortion at the wide-angle end of the projection optical system 3H. FIG. 41 is a diagram showing a spherical aberration, an astigmatism, and a distortion at the telephoto end of the projection optical system 3H. As shown in FIGS. 38 to 41, various aberrations are prevented in the projection optical system 3H according to the embodiment.

### Summary of Present Disclosure

Hereinafter, a summary of the present disclosure will be appended.

### Appendix 1

A projection optical system includes:
a first lens group; a second lens group; a third lens group; a fourth lens group; a fifth lens group; a sixth lens group; a seventh lens group; an eighth lens group; and a ninth lens group, these lens groups being in order from a magnification side to a reduction side; and
an aperture stop disposed between the second lens group and the eighth lens group,
the first lens group has negative power and includes one aspherical lens,
each of the second lens group, the third lens group, the fourth lens group, the fifth lens group, the sixth lens group, the seventh lens group, the eighth lens group, and the ninth lens group includes only a spherical lens, and
during zooming, the first lens group and the ninth lens group are fixed, and the second lens group, the third lens group, the fourth lens group, the fifth lens group, the sixth lens group, the seventh lens group, and the eighth lens group move.

Accordingly, the projection optical system has a compact total lens length while favorably correcting various aberrations even when including only one aspherical lens.

### Appendix 2

In the projection optical system according to appendix 1, during zooming from a wide-angle end to a telephoto end, the second lens group, the third lens group, the fourth lens group, the fifth lens group, the sixth lens group, the seventh lens group, and the eighth lens group move from the reduction side toward the magnification side.

Accordingly, only the second lens group to the eighth lens group move in the same direction during zooming, and thus a structure of a lens barrel for holding the projection optical system can be simplified.

### Appendix 3

In the projection optical system according to Appendix 1 or 2, the second lens group, the third lens group, and the eighth lens group have positive power.

Accordingly, various aberrations occurring in the first lens group having negative power can be favorably corrected by the second lens group and the third lens group both having positive power. Since the eighth lens group has positive power, it is easy to make the reduction side of the projection optical system telecentric.

### Appendix 4

In the projection optical system according to any one of Appendixes 1 to 3, the aperture stop is disposed between the third lens group and the fourth lens group or between the fourth lens group and the fifth lens group.

### Appendix 5

In the projection optical system according to any one of Appendixes 1 to 4, 0.8<F1/Fw<1.6 is satisfied in which F1 is a composite focal length of all of the lenses, which are disposed on the magnification side with respect to the aperture stop, at a wide-angle end, and Fw is a focal length of the entire system at the wide-angle end.

$$0.8 < F 1 / Fw < 1.6 \qquad ( 1 )$$

Accordingly, the projection optical system can favorably correct various aberrations while making a lens length of all the lenses disposed on the magnification side with respect to the aperture stop compact.

### Appendix 6

In the projection optical system according to any one of Appendixes 1 to 5, −9.2<Fgs/Fw<0 is satisfied in which Fgs is a focal length of the lens group which has negative power and which is disposed at a position closest to the aperture stop, and Fw is a focal length of the entire system at a wide-angle end.

$$- 9.2 < Fgs / Fw < 0 \qquad ( 2 )$$

Accordingly, the projection optical system can prevent occurrence of a field curvature and an astigmatism.

### Appendix 7

In the projection optical system according to any one of Appendixes 1 to 6, 3.4<(LL/IH)/(Ft/Fw)<4.9 is satisfied, in which Fw is a focal length of the entire system at a wide-angle end, Ft is a focal length of the entire system at a telephoto end, LL is a total lens length, and IH is a maximum image height on the reduction side.

$$3.4 < ( LL / IH ) / ( Ft / Fw ) < 4.9 \qquad ( 3 )$$

Accordingly, the projection optical system can make the entire system compact while achieving a high zoom ratio.

### Appendix 8

In the projection optical system according to any one of Appendixes 1 to 7, −1.5<Fg1/Fw<−1.0 is satisfied in which Fw is a focal length of the entire system at a wide-angle end and Fg1 is a focal length of the first lens group.

$$- 1.5 < Fg 1 / Fw < - 1.0 \qquad ( 4 )$$

Accordingly, the projection optical system can ensure a back focus while favorably correcting various aberrations.

### Appendix 9

In the projection optical system according to any one of Appendixes 1 to 8, 2.0<Fg2/Fw<7.5 is satisfied in which Fw is a focal length of the entire system at a wide-angle end and Fg2 is a focal length of the second lens group.

$$2. < Fg 2 / Fw < 7.5 \qquad ( 5 )$$

Accordingly, the projection optical system can favorably correct various aberrations while reducing a size thereof.

### Appendix 10

In the projection optical system according to any one of Appendixes 1 to 9,
at least one of the second lens group and the third lens group includes a positive lens having positive power and a negative lens having negative power, and
0.6<Fg2/Fg3<2.4 is satisfied in which Fg2 is a focal length of the second lens group and Fg3 is a focal length of the third lens group.

$$0. 6 < Fg 2 / Fg 3 < 2.4 \qquad ( 6 )$$

Accordingly, the projection optical system can favorably correct a chromatic aberration and various aberrations.

### Appendix 11

The projection optical system according to any one of Appendixes 1 to 10, further includes:
a cemented lens which includes a first lens having positive power and a second lens having negative power, and which is disposed on the magnification side with respect to the aperture stop, and
10<|(Nd1×Vd1)−(Nd2×Vd2)|<20 is satisfied in which Nd1 is a refractive index of the first lens, Nd2 is a refractive index of the second lens, Vd1 is an Abbe number of a d-line of the first lens, and Vd2 is an Abbe number of a d-line of the second lens.

$$10 < \vert ( Nd 1 \times Vd 1 ) - ( Nd 2 \times Vd 2 ) \vert < 20 \qquad ( 7 )$$

Accordingly, the projection optical system can favorably correct a chromatic aberration.

### Appendix 12

In the projection optical system according to Appendix 11, Nd2<1.85 is satisfied in which Nd2 is the refractive index of the second lens.

$$Nd 2 < 1.85 \qquad ( 8 )$$

Accordingly, the projection optical system can favorably correct a chromatic aberration and reduce a cost of a lens material.

### Appendix 13

A projector includes:
the projection optical system according to any one of Appendixes 1 to 12; and
an image forming element configured to form a projection image on a reduction side conjugate plane of the projection optical system.

What is claimed is:

1. A projection optical system comprising:
a first lens group; a second lens group; a third lens group; a fourth lens group; a fifth lens group; a sixth lens group; a seventh lens group; an eighth lens group; and a ninth lens group, these lens groups being in order from a magnification side to a reduction side; and
an aperture stop disposed between the second lens group and the eighth lens group, wherein
the first lens group has negative power and includes one aspherical lens,
each of the second lens group, the third lens group, the fourth lens group, the fifth lens group, the sixth lens group, the seventh lens group, the eighth lens group, and the ninth lens group includes only a spherical lens, and
during zooming, the first lens group and the ninth lens group are fixed, and the second lens group, the third lens group, the fourth lens group, the fifth lens group, the sixth lens group, the seventh lens group, and the eighth lens group move.

2. The projection optical system according to claim 1, wherein
during zooming from a wide-angle end to a telephoto end, the second lens group, the third lens group, the fourth lens group, the fifth lens group, the sixth lens group, the seventh lens group, and the eighth lens group move from the reduction side toward the magnification side.

3. The projection optical system according to claim 1, wherein
the second lens group, the third lens group, and the eighth lens group have positive power.

4. The projection optical system according to claim 1, wherein
the aperture stop is disposed between the third lens group and the fourth lens group or between the fourth lens group and the fifth lens group.

5. The projection optical system according to claim 1, wherein
0.8<F1/Fw<1.6 is satisfied, wherein F1 is a composite focal length of all of the lenses, which are disposed on the magnification side with respect to the aperture stop, at a wide-angle end, and Fw is a focal length of the entire system at the wide-angle end.
$$0.8 < F 1 / Fw < 1.6 \qquad ( 1 )$$

6. The projection optical system according to claim 1, wherein
−9.2<Fgs/Fw<0 is satisfied, wherein Fgs is a focal length of the lens group which has negative power and which is disposed at a position closest to the aperture stop, and Fw is a focal length of the entire system at a wide-angle end.
$$- 9.2 < Fgs / Fw < 0 \qquad ( 2 )$$

7. The projection optical system according to claim 1, wherein
3.4<(LL/IH)/(Ft/Fw)<4.9 is satisfied, wherein Fw is a focal length of the entire system at a wide-angle end, Ft is a focal length of the entire system at a telephoto end, LL is a total lens length, and IH is a maximum image height on the reduction side.
$$3.4 < ( LL / IH ) / ( Ft / Fw ) < 4.9 \qquad ( 3 )$$

8. The projection optical system according to claim 1, wherein
−1.5<Fg1/Fw<−1.0 is satisfied, wherein Fw is a focal length of the entire system at a wide-angle end and Fg1 is a focal length of the first lens group.
$$- 1.5 < Fg 1 / Fw < - 1.0 \qquad ( 4 )$$

9. The projection optical system according to claim 1, wherein
2.0<Fg2/Fw<7.5 is satisfied, wherein Fw is a focal length of the entire system at a wide-angle end and Fg2 is a focal length of the second lens group.
$$2. 0 < Fg 2 / Fw < 7.5 \qquad ( 5 )$$

10. The projection optical system according to claim 1, wherein
at least one of the second lens group and the third lens group includes a positive lens having positive power and a negative lens having negative power, and
0.6<Fg2/Fg3<2.4 is satisfied, wherein Fg2 is a focal length of the second lens group and Fg3 is a focal length of the third lens group.
$$0.6 < Fg 2 / Fg 3 < 2.4 \qquad ( 6 )$$

11. The projection optical system according to claim 1, further comprising:
a cemented lens which includes a first lens having positive power and a second lens having negative power, and which is disposed on the magnification side with respect to the aperture stop, wherein
10<|(Nd1×Vd1)−(Nd2×Vd2)|<20 is satisfied, wherein Nd1 is a refractive index of the first lens, Nd2 is a refractive index of the second lens, Vd1 is an Abbe number of a d-line of the first lens, and Vd2 is an Abbe number of a d-line of the second lens.
$$10 < \vert ( Nd 1 \times Vd 1 ) - ( Nd 2 \times Vd 2 ) \vert < 20 \qquad ( 7 )$$

12. The projection optical system according to claim 11, wherein
Nd2<1.85 is satisfied, wherein Nd2 is the refractive index of the second lens.
$$Nd 2 < 1.85 \qquad ( 8 )$$

13. A projector comprising:
the projection optical system according to claim 1; and
an image forming element configured to form a projection image on a reduction side conjugate plane of the projection optical system.
